(19) United States
(12) Patent Application Publication
(10) Pub. No.: US 2016/0328639 A1
(43) Pub. Date: Nov. 10, 2016

(54) SYSTEM FOR PROVIDING PRIVATE AND PUBLIC CONTENTS WITH TAGS

(71) Applicant: Harold Edward Cohn, Incline Village, NV (US)

(72) Inventor: Harold Edward Cohn, Incline Village, NV (US)

(21) Appl. No.: 15/147,255

(22) Filed: May 5, 2016

Related U.S. Application Data
(60) Provisional application No. 62/158,510, filed on May 7, 2015.

(51) Int. Cl. G06K 19/077; G06K 7/00; G06K 19/06

(52) U.S. Cl. CPC G06K 19/07749; G06K 19/06037; G06K 7/0095

(57) ABSTRACT

A system including an anti-metal tag for determining product ownership and other private information content. The tag includes a private anti-metal tag layer, a metallic backing layer, and an adhesive layer. The metallic backing layer allows tag readers to read the contents of the tag from its non-metallic side surface, but not from the metallic side surface. The adhesive layer allows the tag to attach to an inside or outside wall of a package. The system may additionally contain a public anti-metal tag layer exposed to an outside of the package to provide public information content while the private anti-metal tag layer on the other side faces the inside of the package.

### CROSS-REFERENCE TO RELATED APPLICATIONS

The present Utility patent application claims priority benefit of the U.S. provisional application for patent Ser. No. 62/158,510 entitled “DETERMINING PRODUCT OWNERSHIP, CONVERSIONS, COUPON REDEMPTIONS AND FEEDBACK WITH PRIVATE TAGS” filed on 7 May 2015 under 35 U.S.C. 119(e). The contents of this related provisional application are incorporated herein by reference for all purposes to the extent that such subject matter is not inconsistent herewith or limiting hereof.

### RELATED CO-PENDING U.S. PATENT APPLICATIONS

Not applicable.

### FEDERALLY SPONSORED RESEARCH OR DEVELOPMENT

Not applicable.

### REFERENCE TO SEQUENCE LISTING, A TABLE, OR A COMPUTER LISTING APPENDIX

Not applicable.

### COPYRIGHT NOTICE

A portion of the disclosure of this patent document contains material that is subject to copyright protection by the author thereof. The copyright owner has no objection to the facsimile reproduction by anyone of the patent document or patent disclosure for the purposes of referencing as patent prior art, as it appears in the Patent and Trademark Office, patent file or records, but otherwise reserves all copyright rights whatsoever.

### BACKGROUND OF THE RELEVANT PRIOR ART

One or more embodiments of the invention generally relate to the field of communications. More particularly, certain embodiments of the invention relates to communications devices and related methods that use near-field communication (NFC).

The following background information may present examples of specific aspects of the prior art (e.g., without limitation, approaches, facts, or common wisdom) that, while expected to be helpful to further educate the reader as to additional aspects of the prior art, is not to be construed as limiting the present invention, or any embodiments thereof, to anything stated or implied therein or inferred thereupon.

NFC is a wireless technology that may allow the transfer of data such as a web address, text or numbers between two NFC devices. A tag is one such “device” and is essentially a small microchip containing a small amount of memory attached to an antenna/aerial which can store a small amount of information for transfer to another NFC enabled device, such as a mobile phone, tablet, etc. Because NFC tags work by electromagnetic induction, metal may easily interfere with their operation. It is generally found that NFC tags may not operate if placed directly onto a metal surface. The reason NFC tags don't work on metal is that the metal surface behind the tag acts as a ground plane and reduces the field strength and performance of the tag's antenna, effectively limiting sufficient current needed to power the NFC chip and generate a response. Anti-metal NFC tags, also known as on-metal NFC tags, consist of an NFC antenna with a magnetic (ferrite material or similar) shielding layer. This magnetic layer dramatically improves the field strength of a tag when placed on a metal surface, allowing it to operate, though generally less effectively than an normal open air tag not placed on a metal surface. The ferrite layer may only be a fraction of a millimeter thick. Given the magnetic layer, anti-metal tags usually cost more than standard tags.

The following is an example of a specific aspect in the prior art that, while expected to be helpful to further educate the reader as to additional aspects of the prior art, is not to be construed as limiting the present invention, or any embodiments thereof, to anything stated or implied therein or inferred thereupon. A packaging system for protecting a radio frequency readable label from being read while the label is on or embedded within a packaged product may have been shown. The product packaging may include a shielding member that is rendered unusable upon removal of the product from the packaging.

By way of educational background, another aspect of the prior art generally useful to be aware of is that a communications device may include a near-field communication (NFC) circuit device, and a radio frequency (RF) signal-blocking member adhesively coupled with the NFC device. The RF signal-blocking member may be configured to block RF signal communication by the NFC device. The RF signal-blocking member may comprise an electrical conductor. The RF signal-blocking member may comprise a frangible layer. A pressure sensitive adhesive layer may be included for adhesively securing the RF signal-blocking member with the NFC device.

By way of educational background, another aspect of the prior art generally useful to be aware of is that an apparatus may include a near-field communication (NFC) circuit and an electrically conductive layer. The electrically conductive layer may be removable from the NFC circuit and while the conductive layer is on the NFC circuit a transceiver circuit may be prevented from transmitting.

In view of the foregoing, it is clear that these traditional techniques are not perfect and leave room for more optimal approaches.

### BRIEF DESCRIPTION OF THE DRAWINGS

The present invention is illustrated by way of example, and not by way of limitation, in the figures of the accompanying drawings and in which like reference numerals refer to similar elements and in which:

FIG. 1 illustrates an exemplary private anti-metal tag for determining product ownership, in accordance with an embodiment of the present invention;

FIG. 2 illustrates an exemplary dual public/private anti-metal tag, in accordance with an embodiment of the present invention;

FIG. 3 illustrates an exemplary private anti-metal tag for use with thin products, in accordance with an embodiment of the present invention;

FIG. 4 illustrates an exemplary dual public/private anti-metal tag for use with thin products, in accordance with an embodiment of the present invention;

FIG. 5 illustrates an exemplary private anti-metal tag for use within an envelope, in accordance with an embodiment of the present invention;

FIG. 6 illustrates an exemplary private tag for use within a beverage cap, in accordance with an embodiment of the present invention;

FIGS. 7 and 8 illustrate exemplary non-reading of a private tag within a beverage cap, in accordance with an embodiment of the present invention;

FIG. 9 illustrates an exemplary reading of a private tag within a beverage cap, in accordance with an embodiment of the present invention;

FIG. 10 illustrates an exemplary dual public/private tag for use within a beverage cap, in accordance with an embodiment of the present invention;

FIG. 11 illustrates an exemplary public tag and private tag for use with a packaged product, in accordance with an embodiment of the present invention;

FIG. 12 illustrates an exemplary dual public/private tag for use with a packaged product, in accordance with an embodiment of the present invention;

FIG. 13 illustrates an exemplary private anti-metal tag in use with a thin product, in accordance with an embodiment of the present invention;

FIG. 14 illustrates an exemplary public tag and private tag in use with a packaged product, in accordance with an embodiment of the present invention;

FIG. 15 illustrates an exemplary private tag in use with a protective envelope, in accordance with an embodiment of the present invention;

FIG. 16 illustrates an exemplary tag verification system, in accordance with an embodiment of the present invention;

FIG. 17 illustrates an exemplary geo-tapping tags for determining ownership, in accordance with an embodiment of the present invention;

FIG. 18 illustrates an exemplary geo-tapping tags in multiple location for determining ownership, in accordance with an embodiment of the present invention;

FIG. 19 illustrates an exemplary time line of customers tapping tags on a given product, in accordance with an embodiment of the present invention;

FIG. 20 and FIG. 21 illustrate an exemplary method for tapping a tag for a product, in accordance with an embodiment of the present invention;

FIG. 22 illustrates an exemplary diagram of customers tapping tags on a given product, in accordance with an embodiment of the present invention;

FIG. 23 illustrates an exemplary diagram of multiple product referrals, in accordance with an embodiment of the present invention;

FIG. 24 illustrates an exemplary diagram of mitigating product referral abuse, in accordance with an embodiment of the present invention;

FIG. 25 illustrates an exemplary diagram of service ownership and conversion in a restaurant/service environment, in accordance with an embodiment of the present invention; and

FIG. 26 is a block diagram depicting an exemplary client/server system that may be used by an exemplary web-enabled/networked embodiment of the present invention.

FIG. 27 illustrates multiple forms of tag identification using NFC, QR code and serial number.

Unless otherwise indicated illustrations in the figures are not necessarily drawn to scale.

### DETAILED DESCRIPTION OF SOME EMBODIMENTS

The present invention is best understood by reference to the detailed figures and description set forth herein.

Embodiments of the invention are discussed below with reference to the Figures. However, those skilled in the art will readily appreciate that the detailed description given herein with respect to these figures is for explanatory purposes as the invention extends beyond these limited embodiments. For example, it should be appreciated that those skilled in the art will, in light of the teachings of the present invention, recognize a multiplicity of alternate and suitable approaches, depending upon the needs of the particular application, to implement the functionality of any given detail described herein, beyond the particular implementation choices in the following embodiments described and shown. That is, there are modifications and variations of the invention that are too numerous to be listed but that all fit within the scope of the invention. Also, singular words should be read as plural and vice versa and masculine as feminine and vice versa, where appropriate, and alternative embodiments do not necessarily imply that the two are mutually exclusive.

It is to be further understood that the present invention is not limited to the particular methodology, compounds, materials, manufacturing techniques, uses, and applications, described herein, as these may vary. It is also to be understood that the terminology used herein is used for the purpose of describing particular embodiments only, and is not intended to limit the scope of the present invention. It must be noted that as used herein and in the appended claims, the singular forms “a,” “an,” and “the” include the plural reference unless the context clearly dictates otherwise. Thus, for example, a reference to “an element” is a reference to one or more elements and includes equivalents thereof known to those skilled in the art. Similarly, for another example, a reference to “a step” or “a means” is a reference to one or more steps or means and may include sub-steps and subservient means. All conjunctions used are to be understood in the most inclusive sense possible. Thus, the word “or” should be understood as having the definition of a logical “or” rather than that of a logical “exclusive or” unless the context clearly necessitates otherwise. Structures described herein are to be understood also to refer to functional equivalents of such structures. Language that may be construed to express approximation should be so understood unless the context clearly dictates otherwise.

All words of approximation as used in the present disclosure and claims should be construed to mean “approximate,” rather than “perfect,” and may accordingly be employed as a meaningful modifier to any other word, specified parameter, quantity, quality, or concept. Words of approximation, include, yet are not limited to terms such as “substantial”, “nearly”, “almost”, “about”, “generally”, “largely”, “essentially”, “closely approximate”, etc.

As will be established in some detail below, it is well settle law, as early as 1939, that words of approximation are not indefinite in the claims even when such limits are not defined or specified in the specification.

For example, see Ex parte Mallory, 52 USPQ 297, 297 (Pat. Off. Bd. App. 1941) where the court said “The examiner has held that most of the claims are inaccurate because apparently the laminar film will not be entirely eliminated. The claims specify that the film is “substantially” eliminated and for the intended purpose, it is believed that the slight portion of the film that may remain is negligible. We are of the view, therefore, that the claims may be regarded as sufficiently accurate.”

Note that claims need only “reasonably apprise those skilled in the art” as to their scope to satisfy the definiteness requirement. See Energy Absorption Sys., Inc. v. Roadway Safety Servs., Inc., Civ. App. 96-1264, slip op. at 10 (Fed. Cir. Jul. 3, 1997) (unpublished) Hybridtech v. Monoclonal Antibodies, Inc., 802 F.2d 1367, 1385, 231 USPQ 81, 94 (Fed. Cir. 1986), cert. denied, 480 U.S. 947 (1987). In addition, the use of modifiers in the claim, like “generally” and “substantial,” does not by itself render the claims indefinite. See Seattle Box Co. v. Industrial Crating & Packing, Inc., 731 F.2d 818, 828-29, 221 USPQ 568, 575-76 (Fed. Cir. 1984).

Moreover, the ordinary and customary meaning of terms like “substantially” includes “reasonably close to: nearly, almost, about”, connoting a term of approximation. See In re Frye, Appeal No. 2009-006013, 94 USPQ2d 1072, 1077, 2010 WL 889747 (B.P.A.I. 2010) Depending on its usage, the word “substantially” can denote either language of approximation or language of magnitude. Deering Precision Instruments, L.L.C. v. Vector Distribution Sys., Inc., 347 F.3d 1314, 1323 (Fed. Cir. 2003) (recognizing the “dual ordinary meaning of th[e] term [“substantially”] as connoting a term of approximation or a term of magnitude”). Here, when referring to the “substantially halfway” limitation, the Specification uses the word “approximately” as a substitute for the word “substantially” (Fact 4). (Fact 4). The ordinary meaning of “substantially halfway” is thus reasonably close to or nearly at the midpoint between the forwardmost point of the upper or outsole and the rearwardmost point of the upper or outsole.

Similarly, the term “substantially” is well recognize in case law to have the dual ordinary meaning of connoting a term of approximation or a term of magnitude. See Dana Corp. v. American Axle & Manufacturing, Inc., Civ. App. 04-1116, 2004 U.S. App. LEXIS 18265, *13-14 (Fed. Cir. Aug. 27, 2004) (unpublished). The term “substantially” is commonly used by claim drafters to indicate approximation. See Cordis Corp. v. Medtronic AVE Inc., 339 F.3d 1352, 1360 (Fed. Cir. 2003) (“The patents do not set out any numerical standard by which to determine whether the thickness of the wall surface is “substantially uniform.” The term “substantially,” as used in this context, denotes approximation. Thus, the walls must be of largely or approximately uniform thickness.”); see also Deering Precision Instruments, LLC v. Vector Distribution Sys., Inc., 347 F.3d 1314, 1322 (Fed. Cir. 2003); Epcon Gas Sys., Inc. v. Bauer Compressors, Inc., 279 F.3d 1022, 1031 (Fed. Cir. 2002). We find that the term “substantially” was used in just such a manner in the claims of the patents-in-suit: “substantially uniform wall thickness” denotes a wall thickness with approximate uniformity.

It should also be noted that such words of approximation as contemplated in the foregoing clearly limits the scope of claims such as saying “generally parallel” such that the adverb “generally” does not broaden the meaning of parallel. Accordingly, it is well settled that such words of approximation as contemplated in the foregoing (e.g., like the phrase “generally parallel”) envisions some amount of deviation from perfection (e.g., not exactly parallel), and that such words of approximation as contemplated in the foregoing are descriptive terms commonly used in patent claims to avoid a strict numerical boundary to the specified parameter. To the extent that the plain language of the claims relying on such words of approximation as contemplated in the foregoing are clear and uncontradicted by anything in the written description herein or the figures thereof, it is improper to rely upon the present written description, the figures, or the prosecution history to add limitations to any of the claim of the present invention with respect to such words of approximation as contemplated in the foregoing. That is, under such circumstances, relying on the written description and prosecution history to reject the ordinary and customary meanings of the words themselves is impermissible. See, for example, Liquid Dynamics Corp. v. Vaughan Co., 355 F.3d 1361, 69 USPQ2d 1595, 1600-01 (Fed. Cir. 2004). The plain language of phrase 2 requires a “substantial helical flow.” The term “substantial” is a meaningful modifier implying “approximate,” rather than “perfect.” In Cordis Corp. v. Medtronic AVE, Inc., 339 F.3d 1352, 1361 (Fed. Cir. 2003), the district court imposed a precise numeric constraint on the term “substantially uniform thickness.” We noted that the proper interpretation of this term was “of largely or approximately uniform thickness” unless something in the prosecution history imposed the “clear and unmistakable disclaimer” needed for narrowing beyond this simple-language interpretation. Id. In Anchor Wall Systems v. Rockwood Retaining Walls, Inc., 340 F.3d 1298, 1311 (Fed. Cir. 2003)” Id. at 1311. Similarly, the plain language of Claim 1 requires neither a perfectly helical flow nor a flow that returns precisely to the center after one rotation (a limitation that arises only as a logical consequence of requiring a perfectly helical flow).

The reader should appreciate that case law generally recognizes a dual ordinary meaning of such words of approximation, as contemplated in the foregoing, as connoting a term of approximation or a term of magnitude; e.g., see Deering Precision Instruments, L.L.C. v. Vector Distrib. Sys., Inc., 347 F.3d 1314, 68 USPQ2d 1716, 1721 (Fed. Cir. 2003), cert. denied, 124 S. Ct. 1426 (2004) where the court was asked to construe the meaning of the term “substantially” in a patent claim. Also see Epcon, 279 F.3d at 1031 (“The phrase ‘substantially constant’ denotes language of approximation, while the phrase ‘substantially below’ signifies language of magnitude, i.e., not insubstantial.”). Also, see, e.g., Epcon Gas Sys., Inc. v. Bauer Compressors, Inc., 279 F.3d 1022 (Fed. Cir. 2002) (construing the terms “substantially constant” and “substantially below”); Zodiac Pool Care, Inc. v. Hoffinger Indus., Inc., 206 F.3d 1408 (Fed. Cir. 2000) (construing the term “substantially inward”); York Prods., Inc. v. Cent. Tractor Farm & Family Ctr., 99 F.3d 1568 (Fed. Cir. 1996) (construing the term “substantially the entire height thereof”); Tex. Instruments Inc. v. Cypress Semiconductor Corp., 90 F.3d 1558 (Fed. Cir. 1996) (construing the term “substantially in the common plane”). In conducting their analysis, the court instructed to begin with the ordinary meaning of the claim terms to one of ordinary skill in the art. Prima Tek, 318 F.3d at 1148. Reference to dictionaries and our cases indicates that the term “substantially” has numerous ordinary meanings. As the district court stated, “substantially” can mean “significantly” or “considerably.” The term “substantially” can also mean “largely” or “essentially.” Webster's New 20th Century Dictionary 1817 (1983).

Words of approximation, as contemplated in the foregoing, may also be used in phrases establishing approximate ranges or limits, where the end points are inclusive and approximate, not perfect; e.g., see AK Steel Corp. v. Sollac, 344 F.3d 1234, 68 USPQ2d 1280, 1285 (Fed. Cir. 2003) where it where the court said [W]e conclude that the ordinary meaning of the phrase “up to about 10%” includes the “about 10%” endpoint. As pointed out by AK Steel, when an object of the preposition “up to” is nonnumeric, the most natural meaning is to exclude the object (e.g., painting the wall up to the door). On the other hand, as pointed out by Sollac, when the object is a numerical limit, the normal meaning is to include that upper numerical limit (e.g., counting up to ten, seating capacity for up to seven passengers). Because we have here a numerical limit—“about 10%”—the ordinary meaning is that that endpoint is included.

In the present specification and claims, a goal of employment of such words of approximation, as contemplated in the foregoing, is to avoid a strict numerical boundary to the modified specified parameter, as sanctioned by Pall Corp. v. Micron Separations, Inc., 66 F.3d 1211, 1217, 36 USPQ2d 1225, 1229 (Fed. Cir. 1995) where it states “It is well established that when the term “substantially” serves reasonably to describe the subject matter so that its scope would be understood by persons in the field of the invention, and to distinguish the claimed subject matter from the prior art, it is not indefinite.” Likewise see Verve LLC v. Crane Cams Inc., 311 F.3d 1116, 65 USPQ2d 1051, 1054 (Fed. Cir. 2002). Expressions such as “substantially” are used in patent documents when warranted by the nature of the invention, in order to accommodate the minor variations that may be appropriate to secure the invention. Such usage may well satisfy the charge to “particularly point out and distinctly claim” the invention, 35 U.S.C. §112, and indeed may be necessary in order to provide the inventor with the benefit of his invention. In Andrew Corp. v. Gabriel Elecs. Inc., 847 F.2d 819, 821-22, 6 USPQ2d 2010, 2013 (Fed. Cir. 1988) the court explained that usages such as “substantially equal” and “closely approximate” may serve to describe the invention with precision appropriate to the technology and without intruding on the prior art. The court again explained in Ecolab Inc. v. Envirochem, Inc., 264 F.3d 1358, 1367, 60 USPQ2d 1173, 1179 (Fed. Cir. 2001) that “like the term ‘about,’ the term ‘substantially’ is a descriptive term commonly used in patent claims to avoid a strict numerical boundary to the specified parameter, see Ecolab Inc. v. Envirochem Inc., 264 F.3d 1358, 60 USPQ2d 1173, 1179 (Fed. Cir. 2001) where the court found that the use of the term “substantially” to modify the term “uniform” does not render this phrase so unclear such that there is no means by which to ascertain the claim scope.

Similarly, other courts have noted that like the term “about,” the term “substantially” is a descriptive term commonly used in patent claims to “avoid a strict numerical boundary to the specified parameter.”, e.g., see Pall Corp. v. Micron Seps., 66 F.3d 1211, 1217, 36 USPQ2d 1225, 1229 (Fed. Cir. 1995); see, e.g., Andrew Corp. v. Gabriel Elecs. Inc., 847 F.2d 819, 821-22, 6 USPQ2d 2010, 2013 (Fed. Cir. 1988) (noting that terms such as “approach each other,” “close to,” “substantially equal,” and “closely approximate” are ubiquitously used in patent claims and that such usages, when serving reasonably to describe the claimed subject matter to those of skill in the field of the invention, and to distinguish the claimed subject matter from the prior art, have been accepted in patent examination and upheld by the courts). In this case, “substantially” avoids the strict 100% nonuniformity boundary.

Indeed, the foregoing sanctioning of such words of approximation, as contemplated in the foregoing, has been established as early as 1939, see Ex parte Mallory, 52 USPQ 297, 297 (Pat. Off. Bd. App. 1941) where, for example, the court said “the claims specify that the film is “substantially” eliminated and for the intended purpose, it is believed that the slight portion of the film which may remain is negligible. We are of the view, therefore, that the claims may be regarded as sufficiently accurate.” Similarly, In re Hutchison, 104 F.2d 829, 42 USPQ 90, 93 (C.C.P.A. 1939) the court said “It is realized that “substantial distance” is a relative and somewhat indefinite term, or phrase, but terms and phrases of this character are not uncommon in patents in cases where, according to the art involved, the meaning can be determined with reasonable clearness.”

Hence, for at least the forgoing reason, Applicants submit that it is improper for any examiner to hold as indefinite any claims of the present patent that employ any words of approximation.

Unless defined otherwise, all technical and scientific terms used herein have the same meanings as commonly understood by one of ordinary skill in the art to which this invention belongs. Preferred methods, techniques, devices, and materials are described, although any methods, techniques, devices, or materials similar or equivalent to those described herein may be used in the practice or testing of the present invention. Structures described herein are to be understood also to refer to functional equivalents of such structures. The present invention will be described in detail below with reference to embodiments thereof as illustrated in the accompanying drawings.

References to a “device,” an “apparatus,” a “system,” etc., in the preamble of a claim should be construed broadly to mean “any structure meeting the claim terms” exempt for any specific structure(s)/type(s) that has/(have) been explicitly disavowed or excluded or admitted/implied as prior art in the present specification or incapable of enabling an object/aspect/goal of the invention. Furthermore, where the present specification discloses an object, aspect, function, goal, result, or advantage of the invention that a specific prior art structure and/or method step is similarly capable of performing yet in a very different way, the present invention disclosure is intended to and shall also implicitly include and cover additional corresponding alternative embodiments that are otherwise identical to that explicitly disclosed except that they exclude such prior art structure(s)/step(s), and shall accordingly be deemed as providing sufficient disclosure to support a corresponding negative limitation in a claim claiming such alternative embodiment(s), which exclude such very different prior art structure(s)/step(s) way(s).

From reading the present disclosure, other variations and modifications will be apparent to persons skilled in the art. Such variations and modifications may involve equivalent and other features which are already known in the art, and which may be used instead of or in addition to features already described herein.

Although Claims have been formulated in this Application to particular combinations of features, it should be understood that the scope of the disclosure of the present invention also includes any novel feature or any novel combination of features disclosed herein either explicitly or implicitly or any generalization thereof, whether or not it relates to the same invention as presently claimed in any Claim and whether or not it mitigates any or all of the same technical problems as does the present invention.

Features that are described in the context of separate embodiments may also be provided in combination in a single embodiment. Conversely, various features that are, for brevity, described in the context of a single embodiment, may also be provided separately or in any suitable subcombination. The Applicants hereby give notice that new Claims may be formulated to such features and/or combinations of such features during the prosecution of the present Application or of any further Application derived therefrom.

References to “one embodiment,” “an embodiment,” “example embodiment,” “various embodiments,” “some embodiments,” “embodiments of the invention,” etc., may indicate that the embodiment(s) of the invention so described may include a particular feature, structure, or characteristic, but not every possible embodiment of the invention necessarily includes the particular feature, structure, or characteristic. Further, repeated use of the phrase “in one embodiment,” or “in an exemplary embodiment,” “an embodiment,” do not necessarily refer to the same embodiment, although they may. Moreover, any use of phrases like “embodiments” in connection with “the invention” are never meant to characterize that all embodiments of the invention must include the particular feature, structure, or characteristic, and should instead be understood to mean “at least some embodiments of the invention” includes the stated particular feature, structure, or characteristic.

References to “user”, or any similar term, as used herein, may mean a human or non-human user thereof. Moreover, “user”, or any similar term, as used herein, unless expressly stipulated otherwise, is contemplated to mean users at any stage of the usage process, to include, without limitation, direct user(s), intermediate user(s), indirect user(s), and end user(s). The meaning of “user”, or any similar term, as used herein, should not be otherwise inferred or induced by any pattern(s) of description, embodiments, examples, or referenced prior-art that may (or may not) be provided in the present patent.

References to “end user”, or any similar term, as used herein, is generally intended to mean late stage user(s) as opposed to early stage user(s). Hence, it is contemplated that there may be a multiplicity of different types of “end user” near the end stage of the usage process. Where applicable, especially with respect to distribution channels of embodiments of the invention comprising consumed retail products/services thereof (as opposed to sellers/vendors or Original Equipment Manufacturers), examples of an “end user” may include, without limitation, a “consumer”, “buyer”, “customer”, “purchaser”, “shopper”, “enjoyer”, “viewer”, or individual person or non-human thing benefiting in any way, directly or indirectly, from use of. or interaction, with some aspect of the present invention.

In some situations, some embodiments of the present invention may provide beneficial usage to more than one stage or type of usage in the foregoing usage process. In such cases where multiple embodiments targeting various stages of the usage process are described, references to “end user”, or any similar term, as used therein, are generally intended to not include the user that is the furthest removed, in the foregoing usage process, from the final user therein of an embodiment of the present invention.

Where applicable, especially with respect to retail distribution channels of embodiments of the invention, intermediate user(s) may include, without limitation, any individual person or non-human thing benefiting in any way, directly or indirectly, from use of, or interaction with, some aspect of the present invention with respect to selling, vending, Original Equipment Manufacturing, marketing, merchandising, distributing, service providing, and the like thereof.

References to “person”, “individual”, “human”, “a party”, “animal”, “creature”, or any similar term, as used herein, even if the context or particular embodiment implies living user, maker, or participant, it should be understood that such characterizations are sole by way of example, and not limitation, in that it is contemplated that any such usage, making, or participation by a living entity in connection with making, using, and/or participating, in any way, with embodiments of the present invention may be substituted by such similar performed by a suitably configured non-living entity, to include, without limitation, automated machines, robots, humanoids, computational systems, information processing systems, artificially intelligent systems, and the like. It is further contemplated that those skilled in the art will readily recognize the practical situations where such living makers, users, and/or participants with embodiments of the present invention may be in whole, or in part, replaced with such non-living makers, users, and/or participants with embodiments of the present invention. Likewise, when those skilled in the art identify such practical situations where such living makers, users, and/or participants with embodiments of the present invention may be in whole, or in part, replaced with such non-living makers, it will be readily apparent in light of the teachings of the present invention how to adapt the described embodiments to be suitable for such non-living makers, users, and/or participants with embodiments of the present invention. Thus, the invention is thus to also cover all such modifications, equivalents, and alternatives falling within the spirit and scope of such adaptations and modifications, at least in part, for such non-living entities.

Headings provided herein are for convenience and are not to be taken as limiting the disclosure in any way.

The enumerated listing of items does not imply that any or all of the items are mutually exclusive, unless expressly specified otherwise.

It is understood that the use of specific component, device and/or parameter names are for example only and not meant to imply any limitations on the invention. The invention may thus be implemented with different nomenclature/terminology utilized to describe the mechanisms/units/structures/components/devices/parameters herein, without limitation. Each term utilized herein is to be given its broadest interpretation given the context in which that term is utilized.

### TERMINOLOGY

The following paragraphs provide definitions and/or context for terms found in this disclosure (including the appended claims):

“Comprising.” This term is open-ended. As used in the appended claims, this term does not foreclose additional structure or steps. Consider a claim that recites: “A memory controller comprising a system cache . . . .” Such a claim does not foreclose the memory controller from including additional components (e.g., a memory channel unit, a switch).

“Configured To.” Various units, circuits, or other components may be described or claimed as “configured to” perform a task or tasks. In such contexts, “configured to” or “operable for” is used to connote structure by indicating that the mechanisms/units/circuits/components include structure (e.g., circuitry and/or mechanisms) that performs the task or tasks during operation. As such, the mechanisms/unit/circuit/component can be said to be configured to (or be operable) for perform(ing) the task even when the specified mechanisms/unit/circuit/component is not currently operational (e.g., is not on). The mechanisms/units/circuits/components used with the “configured to” or “operable for” language include hardware—for example, mechanisms, structures, electronics, circuits, memory storing program instructions executable to implement the operation, etc. Reciting that a mechanism/unit/circuit/component is “configured to” or “operable for” perform(ing) one or more tasks is expressly intended not to invoke 35 U.S.C. .sctn.112, sixth paragraph, for that mechanism/unit/circuit/component. “Configured to” may also include adapting a manufacturing process to fabricate devices or components that are adapted to implement or perform one or more tasks

“Based On.” As used herein, this term is used to describe one or more factors that affect a determination. This term does not foreclose additional factors that may affect a determination. That is, a determination may be solely based on those factors or based, at least in part, on those factors. Consider the phrase “determine A based on B.” While B may be a factor that affects the determination of A, such a phrase does not foreclose the determination of A from also being based on C. In other instances, A may be determined based solely on B.

The terms “a”, “an” and “the” mean “one or more”, unless expressly specified otherwise.

Unless otherwise indicated, all numbers expressing conditions, concentrations, dimensions, and so forth used in the specification and claims are to be understood as being modified in all instances by the term “about.” Accordingly, unless indicated to the contrary, the numerical parameters set forth in the following specification and attached claims are approximations that may vary depending at least upon a specific analytical technique.

The term “comprising,” which is synonymous with “including,” “containing,” or “characterized by” is inclusive or open-ended and does not exclude additional, unrecited elements or method steps. “Comprising” is a term of art used in claim language that means that the named claim elements are essential, but other claim elements may be added and still form a construct within the scope of the claim.

As used herein, the phase “consisting of” excludes any element, step, or ingredient not specified in the claim. When the phrase “consists of” (or variations thereof) appears in a clause of the body of a claim, rather than immediately following the preamble, it limits only the element set forth in that clause; other elements are not excluded from the claim as a whole. As used herein, the phase “consisting essentially of” and “consisting of” limits the scope of a claim to the specified elements or method steps, plus those that do not materially affect the basis and novel characteristic(s) of the claimed subject matter (see Norian Corp. v Stryker Corp., 363 F.3d 1321, 1331-32, 70 USPQ2d 1508, Fed. Cir. 2004). Moreover, for any claim of the present invention which claims an embodiment “consisting essentially of” or “consisting of” a certain set of elements of any herein described embodiment it shall be understood as obvious by those skilled in the art that the present invention also covers all possible varying scope variants of any described embodiment(s) that are each exclusively (i.e., “consisting essentially of”) functional subsets or functional combination thereof such that each of these plurality of exclusive varying scope variants each consists essentially of any functional subset(s) and/or functional combination(s) of any set of elements of any described embodiment(s) to the exclusion of any others not set forth therein. That is, it is contemplated that it will be obvious to those skilled how to create a multiplicity of alternate embodiments of the present invention that simply consisting essentially of a certain functional combination of elements of any described embodiment(s) to the exclusion of any others not set forth therein, and the invention thus covers all such exclusive embodiments as if they were each described herein.

With respect to the terms “comprising,” “consisting of” and “consisting essentially of” where one of these three terms is used herein, the presently disclosed and claimed subject matter may include the use of either of the other two terms. Thus in some embodiments not otherwise explicitly recited, any instance of “comprising” may be replaced by “consisting of” or, alternatively, by “consisting essentially of”, and thus, for the purposes of claim support and construction for “consisting of” format claims, such replacements operate to create yet other alternative embodiments “consisting essentially of” only the elements recited in the original “comprising” embodiment to the exclusion of all other elements.

Devices or system modules that are in at least general communication with each other need not be in continuous communication with each other, unless expressly specified otherwise. In addition, devices or system modules that are in at least general communication with each other may communicate directly or indirectly through one or more intermediaries.

A description of an embodiment with several components in communication with each other does not imply that all such components are required. On the contrary a variety of optional components are described to illustrate the wide variety of possible embodiments of the present invention.

As is well known to those skilled in the art many careful considerations and compromises typically must be made when designing for the optimal manufacture of a commercial implementation any system, and in particular, the embodiments of the present invention. A commercial implementation in accordance with the spirit and teachings of the present invention may configured according to the needs of the particular application, whereby any aspect(s), feature(s), function(s), result(s), component(s), approach(es), or step(s) of the teachings related to any described embodiment of the present invention may be suitably omitted, included, adapted, mixed and matched, or improved and/or optimized by those skilled in the art, using their average skills and known techniques, to achieve the desired implementation that addresses the needs of the particular application.

In the following description and claims, the terms “coupled” and “connected,” along with their derivatives, may be used. It should be understood that these terms are not intended as synonyms for each other. Rather, in particular embodiments, “connected” may be used to indicate that two or more elements are in direct physical or electrical contact with each other. “Coupled” may mean that two or more elements are in direct physical or electrical contact. However, “coupled” may also mean that two or more elements are not in direct contact with each other, but yet still cooperate or interact with each other.

A “computer” may refer to one or more apparatus and/or one or more systems that are capable of accepting a structured input, processing the structured input according to prescribed rules, and producing results of the processing as output. Examples of a computer may include: a computer; a stationary and/or portable computer; a computer having a single processor, multiple processors, or multi-core processors, which may operate in parallel and/or not in parallel; a general purpose computer; a supercomputer; a mainframe; a super mini-computer; a mini-computer; a workstation; a micro-computer; a server; a client; an interactive television; a web appliance; a telecommunications device with internet access; a hybrid combination of a computer and an interactive television; a portable computer; a tablet personal computer (PC); a personal digital assistant (PDA); a portable telephone; application-specific hardware to emulate a computer and/or software, such as, for example, a digital signal processor (DSP), a field-programmable gate array (FPGA), an application specific integrated circuit (ASIC), an application specific instruction-set processor (ASIP), a chip, chips, a system on a chip, or a chip set; a data acquisition device; an optical computer; a quantum computer; a biological computer; and generally, an apparatus that may accept data, process data according to one or more stored software programs, generate results, and typically include input, output, storage, arithmetic, logic, and control units.

Those of skill in the art will appreciate that where appropriate, some embodiments of the disclosure may be practiced in network computing environments with many types of computer system configurations, including personal computers, hand-held devices, multi-processor systems, microprocessor-based or programmable consumer electronics, network PCs, minicomputers, mainframe computers, and the like. Where appropriate, embodiments may also be practiced in distributed computing environments where tasks are performed by local and remote processing devices that are linked (either by hardwired links, wireless links, or by a combination thereof) through a communications network. In a distributed computing environment, program modules may be located in both local and remote memory storage devices.

“Software” may refer to prescribed rules to operate a computer. Examples of software may include: code segments in one or more computer-readable languages; graphical and or/textual instructions; applets; pre-compiled code; interpreted code; compiled code; and computer programs.

The example embodiments described herein can be implemented in an operating environment comprising computer-executable instructions (e.g., software) installed on a computer, in hardware, or in a combination of software and hardware. The computer-executable instructions can be written in a computer programming language or can be embodied in firmware logic. If written in a programming language conforming to a recognized standard, such instructions can be executed on a variety of hardware platforms and for interfaces to a variety of operating systems. Although not limited thereto, computer software program code for carrying out operations for aspects of the present invention can be written in any combination of one or more suitable programming languages, including an object oriented programming languages and/or conventional procedural programming languages, and/or programming languages such as, for example, Hypertext Markup Language (HTML), Dynamic HTML, Extensible Markup Language (XML), Extensible Stylesheet Language (XSL), Document Style Semantics and Specification Language (DSSSL), Cascading Style Sheets (CSS), Synchronized Multimedia Integration Language (SMIL), Wireless Markup Language (WML), Java™, Jini™, C, C++, Smalltalk, Perl, UNIX Shell, Visual Basic or Visual Basic Script, Virtual Reality Markup Language (VRML), ColdFusion™ or other compilers, assemblers, interpreters or other computer languages or platforms.

Computer program code for carrying out operations for aspects of the present invention may be written in any combination of one or more programming languages, including an object oriented programming language such as Java, Smalltalk, C++ or the like and conventional procedural programming languages, such as the “C” programming language or similar programming languages. The program code may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider).

A network is a collection of links and nodes (e.g., multiple computers and/or other devices connected together) arranged so that information may be passed from one part of the network to another over multiple links and through various nodes. Examples of networks include the Internet, the public switched telephone network, the global Telex network, computer networks (e.g., an intranet, an extranet, a local-area network, or a wide-area network), wired networks, and wireless networks.

The Internet is a worldwide network of computers and computer networks arranged to allow the easy and robust exchange of information between computer users. Hundreds of millions of people around the world have access to computers connected to the Internet via Internet Service Providers (ISPs). Content providers (e.g., website owners or operators) place multimedia information (e.g., text, graphics, audio, video, animation, and other forms of data) at specific locations on the Internet referred to as webpages. Websites comprise a collection of connected, or otherwise related, webpages. The combination of all the websites and their corresponding webpages on the Internet is generally known as the World Wide Web (WWW) or simply the Web.

Aspects of the present invention are described below with reference to flowchart illustrations and/or block diagrams of methods, apparatus (systems) and computer program products according to embodiments of the invention. It will be understood that each block of the flowchart illustrations and/or block diagrams, and combinations of blocks in the flowchart illustrations and/or block diagrams, can be implemented by computer program instructions. These computer program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks.

The flowchart and block diagrams in the figures illustrate the architecture, functionality, and operation of possible implementations of systems, methods and computer program products according to various embodiments. In this regard, each block in the flowchart or block diagrams may represent a module, segment, or portion of code, which comprises one or more executable instructions for implementing the specified logical function(s). It should also be noted that, in some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts, or combinations of special purpose hardware and computer instructions.

These computer program instructions may also be stored in a computer readable medium that can direct a computer, other programmable data processing apparatus, or other devices to function in a particular manner, such that the instructions stored in the computer readable medium produce an article of manufacture including instructions which implement the function/act specified in the flowchart and/or block diagram block or blocks.

Further, although process steps, method steps, algorithms or the like may be described in a sequential order, such processes, methods and algorithms may be configured to work in alternate orders. In other words, any sequence or order of steps that may be described does not necessarily indicate a requirement that the steps be performed in that order. The steps of processes described herein may be performed in any order practical. Further, some steps may be performed simultaneously.

It will be readily apparent that the various methods and algorithms described herein may be implemented by, e.g., appropriately programmed general purpose computers and computing devices. Typically a processor (e.g., a microprocessor) will receive instructions from a memory or like device, and execute those instructions, thereby performing a process defined by those instructions. Further, programs that implement such methods and algorithms may be stored and transmitted using a variety of known media.

When a single device or article is described herein, it will be readily apparent that more than one device/article (whether or not they cooperate) may be used in place of a single device/article. Similarly, where more than one device or article is described herein (whether or not they cooperate), it will be readily apparent that a single device/article may be used in place of the more than one device or article.

The functionality and/or the features of a device may be alternatively embodied by one or more other devices that are not explicitly described as having such functionality/features. Thus, other embodiments of the present invention need not include the device itself.

The term “computer-readable medium” as used herein refers to any medium that participates in providing data (e.g., instructions) that may be read by a computer, a processor or a like device. Such a medium may take many forms, including but not limited to, non-volatile media, volatile media, and transmission media. Non-volatile media include, for example, optical or magnetic disks and other persistent memory. Volatile media include dynamic random access memory (DRAM), which typically constitutes the main memory. Transmission media include coaxial cables, copper wire and fiber optics, including the wires that comprise a system bus coupled to the processor. Transmission media may include or convey acoustic waves, light waves and electromagnetic emissions, such as those generated during radio frequency (RF) and infrared (IR) data communications. Common forms of computer-readable media include, for example, a floppy disk, a flexible disk, hard disk, magnetic tape, any other magnetic medium, a CD-ROM, DVD, any other optical medium, punch cards, paper tape, any other physical medium with patterns of holes, a RAM, a PROM, an EPROM, a FLASH-EEPROM, removable media, flash memory, a “memory stick”, any other memory chip or cartridge, a carrier wave as described hereinafter, or any other medium from which a computer can read.

Various forms of computer readable media may be involved in carrying sequences of instructions to a processor. For example, sequences of instruction (i) may be delivered from RAM to a processor, (ii) may be carried over a wireless transmission medium, and/or (iii) may be formatted according to numerous formats, standards or protocols, such as Bluetooth, TDMA, CDMA, 3G.

Where databases are described, it will be understood by one of ordinary skill in the art that (i) alternative database structures to those described may be readily employed, (ii) other memory structures besides databases may be readily employed. Any schematic illustrations and accompanying descriptions of any sample databases presented herein are exemplary arrangements for stored representations of information. Any number of other arrangements may be employed besides those suggested by the tables shown. Similarly, any illustrated entries of the databases represent exemplary information only; those skilled in the art will understand that the number and content of the entries can be different from those illustrated herein. Further, despite any depiction of the databases as tables, an object-based model could be used to store and manipulate the data types of the present invention and likewise, object methods or behaviors can be used to implement the processes of the present invention.

A “computer system” may refer to a system having one or more computers, where each computer may include a computer-readable medium embodying software to operate the computer or one or more of its components. Examples of a computer system may include: a distributed computer system for processing information via computer systems linked by a network; two or more computer systems connected together via a network for transmitting and/or receiving information between the computer systems; a computer system including two or more processors within a single computer; and one or more apparatuses and/or one or more systems that may accept data, may process data in accordance with one or more stored software programs, may generate results, and typically may include input, output, storage, arithmetic, logic, and control units.

A “network” may refer to a number of computers and associated devices that may be connected by communication facilities. A network may involve permanent connections such as cables or temporary connections such as those made through telephone or other communication links. A network may further include hard-wired connections (e.g., coaxial cable, twisted pair, optical fiber, waveguides, etc.) and/or wireless connections (e.g., radio frequency waveforms, free-space optical waveforms, acoustic waveforms, etc.). Examples of a network may include: an internet, such as the Internet; an intranet; a local area network (LAN); a wide area network (WAN); and a combination of networks, such as an internet and an intranet.

As used herein, the “client-side” application should be broadly construed to refer to an application, a page associated with that application, or some other resource or function invoked by a client-side request to the application. A “browser” as used herein is not intended to refer to any specific browser (e.g., Internet Explorer, Safari, FireFox, or the like), but should be broadly construed to refer to any client-side rendering engine that can access and display Internet-accessible resources. A “rich” client typically refers to a non-HTTP based client-side application, such as an SSH or CFIS client. Further, while typically the client-server interactions occur using HTTP, this is not a limitation either. The client server interaction may be formatted to conform to the Simple Object Access Protocol (SOAP) and travel over HTTP (over the public Internet), FTP, or any other reliable transport mechanism (such as IBM® MQSeries® technologies and CORBA, for transport over an enterprise intranet) may be used. Any application or functionality described herein may be implemented as native code, by providing hooks into another application, by facilitating use of the mechanism as a plug-in, by linking to the mechanism, and the like.

Exemplary networks may operate with any of a number of protocols, such as Internet protocol (IP), asynchronous transfer mode (ATM), and/or synchronous optical network (SONET), user datagram protocol (UDP), IEEE 802.x, etc.

Embodiments of the present invention may include apparatuses for performing the operations disclosed herein. An apparatus may be specially constructed for the desired purposes, or it may comprise a general-purpose device selectively activated or reconfigured by a program stored in the device.

Embodiments of the invention may also be implemented in one or a combination of hardware, firmware, and software. They may be implemented as instructions stored on a machine-readable medium, which may be read and executed by a computing platform to perform the operations described herein.

More specifically, as will be appreciated by one skilled in the art, aspects of the present invention may be embodied as a system, method or computer program product. Accordingly, aspects of the present invention may take the form of an entirely hardware embodiment, an entirely software embodiment (including firmware, resident software, micro-code, etc.) or an embodiment combining software and hardware aspects that may all generally be referred to herein as a “circuit,” “module” or “system.” Furthermore, aspects of the present invention may take the form of a computer program product embodied in one or more computer readable medium(s) having computer readable program code embodied thereon.

In the following description and claims, the terms “computer program medium” and “computer readable medium” may be used to generally refer to media such as, but not limited to, removable storage drives, a hard disk installed in hard disk drive, and the like. These computer program products may provide software to a computer system. Embodiments of the invention may be directed to such computer program products.

An algorithm is here, and generally, considered to be a self-consistent sequence of acts or operations leading to a desired result. These include physical manipulations of physical quantities. Usually, though not necessarily, these quantities take the form of electrical or magnetic signals capable of being stored, transferred, combined, compared, and otherwise manipulated. It has proven convenient at times, principally for reasons of common usage, to refer to these signals as bits, values, elements, symbols, characters, terms, numbers or the like. It should be understood, however, that all of these and similar terms are to be associated with the appropriate physical quantities and are merely convenient labels applied to these quantities.

Unless specifically stated otherwise, and as may be apparent from the following description and claims, it should be appreciated that throughout the specification descriptions utilizing terms such as “processing,” “computing,” “calculating,” “determining,” or the like, refer to the action and/or processes of a computer or computing system, or similar electronic computing device, that manipulate and/or transform data represented as physical, such as electronic, quantities within the computing system's registers and/or memories into other data similarly represented as physical quantities within the computing system's memories, registers or other such information storage, transmission or display devices.

Additionally, the phrase “configured to” or “operable for” can include generic structure (e.g., generic circuitry) that is manipulated by software and/or firmware (e.g., an FPGA or a general-purpose processor executing software) to operate in a manner that is capable of performing the task(s) at issue. “Configured to” may also include adapting a manufacturing process (e.g., a semiconductor fabrication facility) to fabricate devices (e.g., integrated circuits) that are adapted to implement or perform one or more tasks.

In a similar manner, the term “processor” may refer to any device or portion of a device that processes electronic data from registers and/or memory to transform that electronic data into other electronic data that may be stored in registers and/or memory. A “computing platform” may comprise one or more processors.

Embodiments within the scope of the present disclosure may also include tangible and/or non-transitory computer-readable storage media for carrying or having computer-executable instructions or data structures stored thereon. Such non-transitory computer-readable storage media can be any available media that can be accessed by a general purpose or special purpose computer, including the functional design of any special purpose processor as discussed above. By way of example, and not limitation, such non-transitory computer-readable media can include RAM, ROM, EEPROM, CD-ROM or other optical disk storage, magnetic disk storage or other magnetic storage devices, or any other medium which can be used to carry or store desired program code means in the form of computer-executable instructions, data structures, or processor chip design. When information is transferred or provided over a network or another communications connection (either hardwired, wireless, or combination thereof) to a computer, the computer properly views the connection as a computer-readable medium. Thus, any such connection is properly termed a computer-readable medium. Combinations of the above should also be included within the scope of the computer-readable media.

While a non-transitory computer readable medium includes, but is not limited to, a hard drive, compact disc, flash memory, volatile memory, random access memory, magnetic memory, optical memory, semiconductor based memory, phase change memory, optical memory, periodically refreshed memory, and the like; the non-transitory computer readable medium, however, does not include a pure transitory signal per se; i.e., where the medium itself is transitory.

It is to be understood that any exact measurements/dimensions or particular construction materials indicated herein are solely provided as examples of suitable configurations and are not intended to be limiting in any way. Depending on the needs of the particular application, those skilled in the art will readily recognize, in light of the following teachings, a multiplicity of suitable alternative implementation details.

In many embodiments, and variation thereof, product ownership may be determined through the use, application and placement of new tag configurations such as, without limitation, a water bottle, a cereal box, an appliance, a candy bar, and in a service environment such as, but not limited to, a restaurant, spa, salon or retailer. Numerous additional embodiments may be extrapolated from these. Some embodiments may utilize a new series of unique NFC tag configurations that may make use of anti-metal tags to prevent a tag from being read until after its associated product may have been acquired and opened. In some embodiments, tapping a product's tag represents a “conversion” or product sale. In some embodiments, conversion tracking may be accomplished by determining the owner(s) of a product. In some embodiments, referral fraud may be prevented and products may have configurable owner group sizes to limit the number of potential owners for a given product purchase. In some embodiments, product returns may be handled in terms of product ownership claim. In some embodiments, methods of determining product ownership, may be, without limitation, based on geo-location of where a product's tag is read, using quick response (QR) Codes or barcodes, and using unique text strings.

In some embodiments, one may instantly and reliably determine product ownership using NFC tags at or after the time of purchase without resorting to external methods such as, without limitation, sending a receipt to a manufacturer or getting in the middle of a payment transaction. It is believed that ownership determination may be important for a number of reasons. For example, without limitation, to track conversions in a referral or advertising system, to determine number of times a specific user has purchased a specific kind of product, to learn where and roughly when purchases are opened and consumed, to provide special rewards for owners, and learn how often people purchase and open specific products.

In the present invention the term “public tag” may refer to an NFC tag that any number of customers may read using their NFC enabled device such as, without limitation, a smartphone, tablet, etc. to get information about, without limitation, a product, a store, a restaurant, an employee, etc., often prior to purchase. The present invention does not limit where a tag may be placed or even if the product of such a tag has been purchased, as it may have been a gift, as a non-limiting example. In some embodiments, after purchase, a public tag might be used to obtain product manuals, warranty and service information as well as coupons for future purchases.

In the present invention the term “private tag” may refer to an NFC tag usually connected to, without limitation, a product, service, restaurant, employee, etc. that cannot be read by a customer or their NFC enabled device until an owner opens and/or consumes a product. In some embodiments, the tags may be used with products, but may be used with services as well.

Private tags may solve the problem of identifying when and what has been purchased, and who has opened a package or accepted service. The tag used for every product instance may also have a globally unique ID otherwise all product instances would have the same owner, i.e., the first customer who taps on any of the non-unique private ID's. Without a unique tag ID, it may be difficult to determine if a customer has purchased the same product multiple times, which is of great interest to businesses. It may not be possible to perform referral and conversion tracking because it may not be possible to uniquely identify a verified purchase. To positively link a private tag to a purchaser, in embodiments of the present invention, the private tag may have a unique ID and a system capable of recording a link between product instance's tag ID and first persons to tap its tag. Embodiments of the present invention may require programming a read-only, globally unique ID into every private tag of a given product type, both encoded into each tag.

Public tags also benefit from globally unique identifiers that may allow businesses to determine who, when, what and where a package is being tapped publicly. For example, it is possible to determine how many times specific package instances are tapped.

Due to memory space limitations within an NFC chip utilized, and for security purposes, it may be necessary to program NFC chips with an opaque hash identifier. This ID is a key that maps to a remote server database record which contains information about the associated product SKU, brand owner, tag history, marketing campaigns, polls, offers, current owner(s), etc. Because all of the useful information is stored remotely on a server database, and not in the tag itself, it also prevents hackers from creating fraudulent tags.

To implement a unique tag ID system may require creating said unique IDs ahead of time, storing them in the database and programming each tag at the factory.

The simplistic approach may be to program a read-only serial number such as, without limitation, an incrementing integer into each tag at the factory. The problem with this approach is that it may be easily foiled through brute force attack upon a server by issuing fake taps for products that hackers haven't actually purchased. While this form of attack may be discovered by the frequency of requests to a server and shut down, a layer of protection may be useful to prevent hackers from bothering to issue attacks in the first place. And while the value of conversion may not be high for individual attacks, larger attacks become a problem and degrade the value of the entire solution.

To solve this problem, embodiments of the present invention may call for programming tags with a series of sparse IDs so that unowned product tags may not be easily be guessed by hacking systems. An encrypted hash like SHA1 or SHA2 may be sufficient. SHA1 is 20 bytes long (160 bits) and represents 1.46×10⁴⁸ possible values, far greater than the number of unique product instances that may be produced by any manufacturer. Even if a manufacturer sells more than 100 million products for the life of a product, each with a unique ID, there are still 1.46×10⁴⁰ additional IDs in the hash space, clearly and enormous range. SHA2 increases the hash space from 224 to 512 bits offering 2.7×10⁶⁷ to 1.3×10¹⁵⁴ values, respectively. Hacking therefore becomes virtually impossible and not worth the effort.

To further thwart hackers, one may not also use an incrementing value to generate a hash. That would be like guessing simple passwords because it's too easy to generate a hash from an incrementing number. To make hashes sufficiently hard to break, embodiments of the present invention may call for a secret key, not easily guessed, to be applied to a whole number sequence. In a non-limiting example, creating a sequence such as hashing a string sequence of “bigbird”+<reversed number>+“hairspray” would be sufficient to create an encrypted hash that may be near impossible to thwart.

In some embodiments of the present invention, the first person that may tap a specific private tag may be considered to be its product's primary owner, but it may be possible that additional people may subsequently tap the same tag. In this case the tag may continue to act like a public tag. However, for the purpose of conversion tracking, in some embodiments, the first few who tap a private tag may also be considered co-owners depending on the product type.

In some embodiments of the present invention, in addition to defining an ownership group size that may limit the number of potential owners for a specific product purchased, it may also be possible limit ownership by time and location. In some embodiments, after a tag is first tapped, it may be configured to expire for ownership after a specified duration as well a number of tappers. As a non-limiting example, open ownership period may end the sooner of expiration or owner group size is exhausted.

In some embodiments of the present invention, owner group may also be limited by location if desired. The system may note the location where the private tag was first tapped. It may then prevent new people from tapping and claiming ownership who are outside a configured radius from the initial tap location.

Some embodiments of the present invention may solve the problem of potential referral abuse and fraud during conversion tracking by preventing conversion of referrals that tap the same private tag originally claimed by the referrer.

Inevitably some customers may return products after reading their product's private tag and claiming ownership. As far as conversion tracking is concerned, however, the product was already legitimately considered owned once its private tag was tapped. The problem becomes how to reset the product's private tag owner when a new buyer repurchases the returned product.

Consumables may be a simple case. Once opened, returned consumables may not generally be resold and usually discarded. The problem becomes more pronounced with durable goods such as, but not limited to, appliances, TVs and automobiles. Again, if a user opens a new TV and taps its private tag, the purchase has been made for conversion tracking. If they return the product, the concern becomes resetting the tag for the next purchaser if the retailer attempts to resell the returned product. Two possible solutions exist which are inconvenient: (a) manufacturers may instruct retailers to scan returned tags and reset them using a designated app, or (b) ask retailers to replace the tag, but this may require stocking of additional tags and may be more complex and error prone.

In some embodiments of the present invention, to avoid these complex solutions, a manufacturer may simply increase the owner group size to account for a few more potential owners. In a non-limiting example, it is likely that television will be returned more than once or even twice, so a conversion group size of three or four might be an acceptable tradeoff. Unopened product packages returned are not a concern. Many types of open products cannot be returned such as food, supplements, medication, beverages and other consumables. Some returned products, such as appliances, are returned to the manufacturer for refurbishment where private tag ownership can be reset and any previous rebate redemption can be clawed back from a previous owner.

In some embodiments, an NFC tag may include a printed QR code on one or both sides for consumer devices that do not have ability to read NFC. In some embodiments, a private tag may include a unique printed serial number that a user can enter into a form if they are unable to scan an NFC tag or QR code. In some embodiments, unique tag identifiers may be generated by and/or stored on a server that dynamically maps tag ID's to, without limitation, product SKU, manufacturer, current campaign associated with tag, etc. This may allow tags to be repurposed over time if desired. In some embodiments, a unique tag ID may allow a server to store raw data about a tag tap event, including, but not limited to, who, where, when and what tapped. In some embodiments, an owner may opt-in or out of receiving solicitations by the brand once tapped. In some embodiments, tapping either tag may let the user add the product, brand, or product category to their wish list. In some embodiments, a server may present the user a custom offer in form of coupon or rebate based on various criteria including, but not limited to, customer demographic, customer location, customer purchase history, customer reward points earned, number of successful customer referrals made, manufacturer desire to move product more quickly, to A/B test offers, etc. Some embodiments, may provide for auto bargaining that may allow the user to tell the server their desired purchase price. The server may able to decide on the spot whether it may meet the user's request, propose something between his desired price and current retail price. If the user doesn't accept the current offer, the server may store the request. In some embodiments, tags may provide service for many years, so buyers may re-tap the tags on their product packaging or product itself to receive extended value. In some embodiments, brands may continually make new offers to buyers to keep them coming back for more. Tags may display product info, warranty info, and service locations, etc. as well as bring buyers back into the server network. This may also provide brands with data on how long their products are stored and/or used in by buyers. In some embodiments, tapping a public/private tag may display, without limitation, advertising and promotions for other products by the brand, products from a brand's other product categories, bundles, sister brands, and even complementary products and services from other manufacturers. In some embodiments, tapping a public/private tag may solicit shoppers to sign up for a subscription to receive automatic reorders. In some embodiments, given unique tag identifiers, it may be possible to register specific product instances more easily for users. A server may further map those tag identifiers to product serial numbers to preclude buyers from having to enter this information into a form, along with date of purchase.

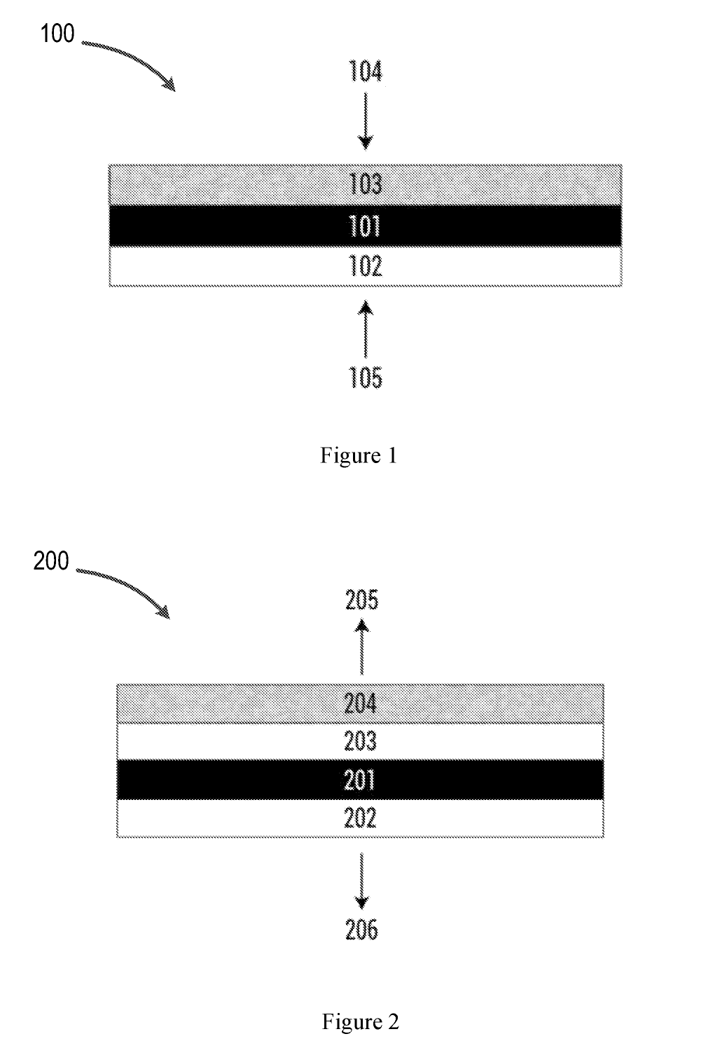

FIG. 1 illustrates an exemplary private anti-metal tag for determining product ownership, in accordance with an embodiment of the present invention. In the present embodiment, a private tag 100 may include an anti-metal NFC tag 102, a metallic backing layer 101, and an adhesive layer 103. Metallic backing layer 101 may allow people to read private tag 102 from its non-metallic side 105, but not from the metallic side 104. Typically, metallic layer 101 may be thin but should be extended to the same diameter/width of private tag 102 to prevent reading from direction 104. Metallic layer 101 is a non-magnetic material such as aluminum, generally greater than 0.04 millimeters thick. Anti-metal NFC tag 102 may have a magnetic ferrite foil layer between an NFC antenna and an adhesive layer that may attach to metallic layer 101. Alternatively, the anti-metal NFC tag 102 may generally have a magnetic layer between an NFC antenna and an adhesive layer that may attach to metallic layer 101. The ferrite foil, or similar, layer may effectively increase field strength in terms of electromagnetic induction so that a field strength of the NFC tag's antenna may be enhanced or extended. Generally, the ferrite foil may only be a fraction of a millimeter thick. In some embodiments, adhesive layer 103 may be optional. Scanning to read the contents of or tap the anti-metal NFC tag 102 may generally include aligning the NFC tag's antenna with a scanner and/or the NFC tag 102 is facing the scanner. Alternatively, to read the contents of or tap the anti-metal NFC tag 102, the scanner is positioned to face the anti-metal NFC tag 102 and/or vice versa. The anti-metal NFC tag 102 may be scanned or tapped by a mobile or fixed scanner. A mobile scanner may be positioned within a predetermined scanning distance in order to read or tap the anti-metal NFC tag 102. A mobile scanner may include a smart or mobile phone with an NFC reader app. A fixed scanner may include a point of sale (POS) device.

FIG. 2 illustrates an exemplary dual public/private anti-metal tag, in accordance with an embodiment of the present invention. In the present embodiment, a dual public/private anti-metal tag 200 may include an anti-metal tag 202, an anti-metal tag 203 separated by a metallic layer 201, and an adhesive layer 204. This configuration may allow one to read both tags but only receive data from one at a time, the tag on the side they are reading from, effectively hiding the other tag. It may be normally possible to be able to read multiple tags simultaneously when placed together in front of a tag reader. Metallic layer 201 sandwiched between the tags 202 and 203 may prevent that from happening. As a non-limiting example, the present embodiment may work well in a retail environment where it may be desirable to have both public 203 and private 202 tags attached to packaging, but only allow the private tag 202 to be read once the buyer opens the package. In some embodiments, the orientation of dual public/private anti-metal tag 200 may be to place the side with the adhesive 204 on the inside of a package wall. The tag 203 with adhesive layer 204 becomes the public tag, while the tag 202 on the other side of metallic layer 201 becomes the private tag that faces inward 206 toward the product within. In some embodiments, adhesive layer 204 may be optional.

Some embodiments may be to attach this tag configuration to the inside wall of a package. This may offer several benefits. The first may be that it allows customers to scan the public tag from the outside of the packaging 205, while being unable to read tag 202 from the outside. The second may be when the package is opened. Tag 202 becomes exposed and able to be read from direction 206. As a non-limiting example, because a public tag 203 may be hidden inside the packaging, a manufacturer may simply print an indication on the outside to let consumers know where to tap. The third benefit may be to protect the tag configuration from intentional or accidental tampering by careless or malicious customers. Once a consumer obtains and opens a package, they read private tag 202 and may be considered the product's new owner.

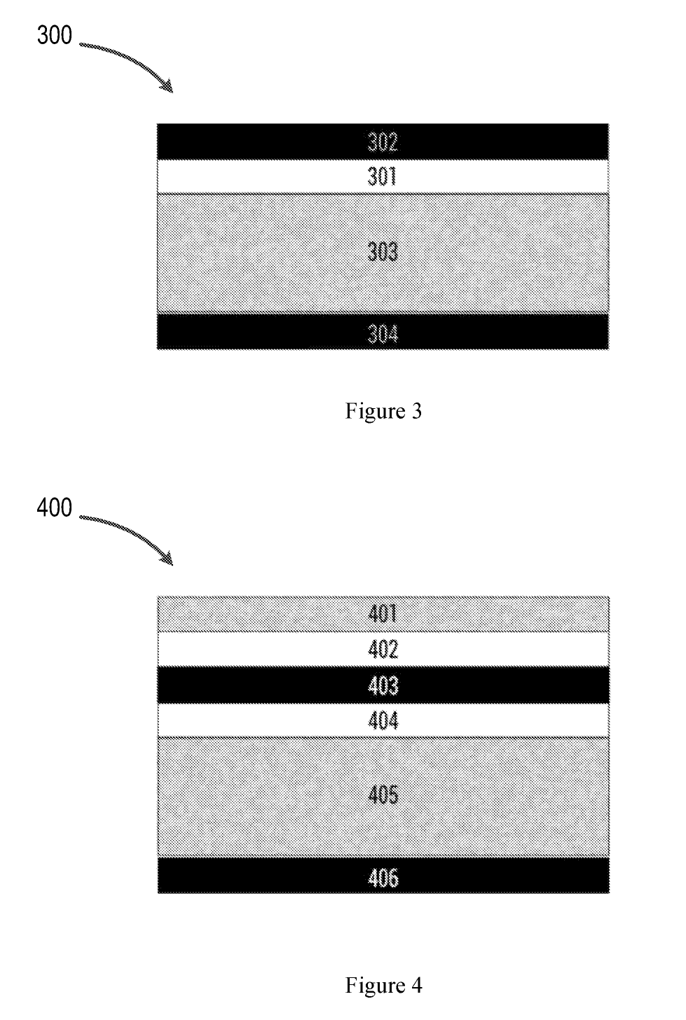

FIG. 3 illustrates an exemplary private anti-metal tag for use with thin products, in accordance with an embodiment of the present invention. In the present embodiment, a private tag 300 may include private anti-metal tag 301, and metallic layers, packaging or wrapping 302 and 304 encasing tag 301 and a thin inner product 303. A metallic packaging layer 304 is placed opposite tag 301 to prevent reading until the package is opened. Metallic layer 304 could be an encompassing packaging layer that surrounds the entire inner product 303, or it could be a small metallic layer placed opposite the tag whose diameter is greater than the tag to prevent premature reading of the tag, especially if shifting packaging is not anticipated. The present embodiment may be for use with thin products where the tag 301 might be readable from the opposite side of the package such as, without limitation, a thin candy bar 303, so it may be surrounding by a metallic layer 302 and 304 to prevent accidental reading until the package in opened by the owner.

FIG. 4 illustrates an exemplary dual public/private anti-metal tag for use with thin products, in accordance with an embodiment of the present invention. In the present embodiment, a dual public/private anti-metal tag 400 may include a public anti-metal tag 402, private anti-metal tag 404, metallic separation layer 403, adhesive 401, opposite metallic layer 406 on other side of thin product 405 and private tag 404. In the present embodiment, non-purchasing consumers may tap the outside of the public tag 402 to get deals and public content. In some embodiments, adhesive 401 may be optional.

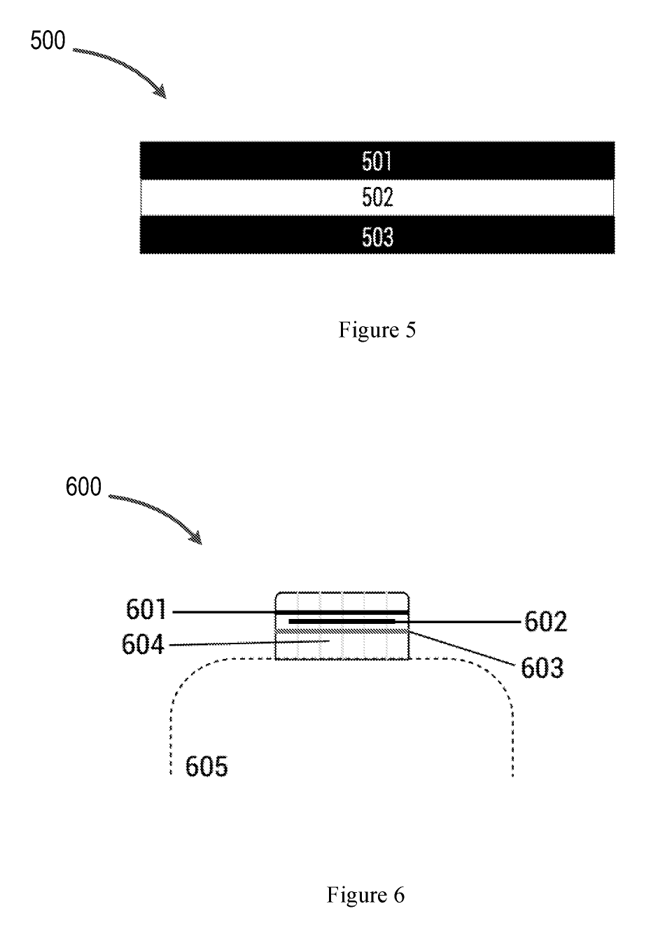

FIG. 5 illustrates an exemplary private anti-metal tag for use within an envelope, in accordance with an embodiment of the present invention. In the present embodiment, a private tag 500 may include a private anti-metal tag 502 and metallic enclosing layers 501 and 503. In the present embodiment, metallic layers 501 and 503 may prevent the tag 502 from being read until the tag is removed from the metallic sandwich. In some embodiments, the metallic sandwich may comprise a temporary envelop with metallic sides to prevent accidental reading until the tag is removed. In some embodiments, the temporary envelop may be attached externally to products like, without limitation, clothing or could be affixed to inside of packaging to ensure tag is never readable, where a buyer may have to open the envelope to securely read the private tag within.

FIG. 6 illustrates an exemplary private tag for use within a beverage cap, in accordance with an embodiment of the present invention. In the present embodiment, a private tag 600 may include an anti-metal private tag 602, a metallic layer 601, and a liquid barrier 603 for tag protection and FDA approval. Typically, during manufacture of a cap 604, thin metallic foil layer 601 may be applied first to the inside, followed by private tag 602 (or tag may be pre-formulated with a metallic layer) and usually followed by a protective liquid barrier 603. Cap 604 may contain barrier 603 to protect tag 602 from liquid in a container 605 that could damage its electrical components. In some alternate embodiments, tag 602 and metallic layer 601 may be encased in a liquid barrier and then joined to the inside of cap 604. In some other alternate embodiments, tag 602 may be encased in a liquid barrier and then joined to metallic layer 601 inside of cap 604. In some other alternate embodiments, if cap 604 is metallic, metallic layer 601 may not be needed. In the present embodiment, tag 602 may not be read from the outside until cap 604 is removed from container 605.

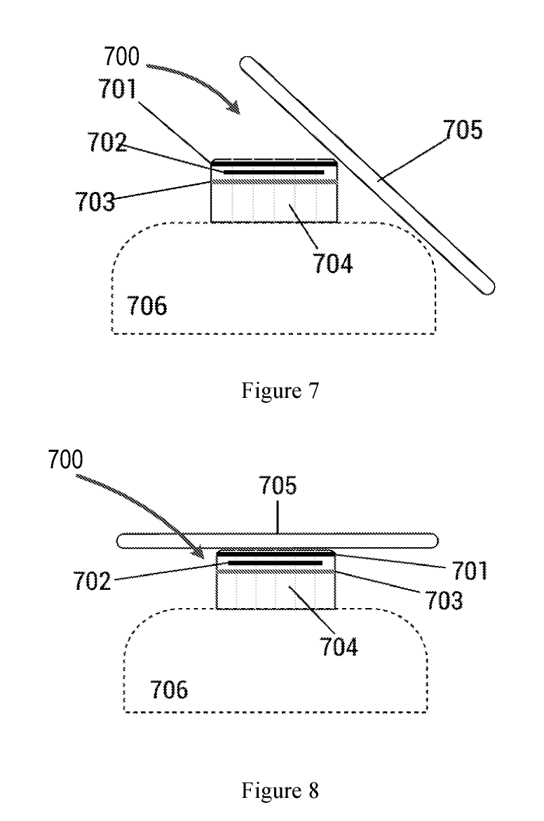

FIGS. 7 and 8 illustrate exemplary non-reading of a private tag within a beverage cap, in accordance with an embodiment of the present invention. In the present embodiment, a private tag 700 may include an anti-metal private tag 702, a metallic layer 701, and a liquid barrier 703 inside a cap 704 secured to a container 706. Metallic layer 701 blocks tag 702 from being read by a NFC tag reader 705 from the top or sides of cap 704 while cap 704 is secured to container 706 and a person may not claim ownership of container 706.

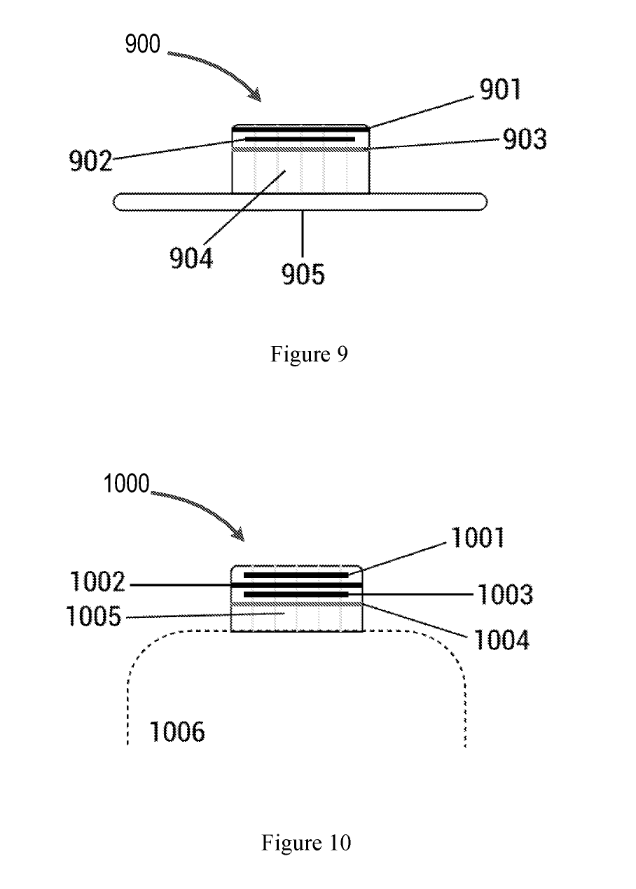

FIG. 9 illustrates an exemplary reading of a private tag within a beverage cap, in accordance with an embodiment of the present invention. In the present embodiment, a private tag 900 may include an anti-metal private tag 902, a metallic layer 901, and a liquid barrier 903 inside a cap 904 removed from a container. As shown in FIG. 9, metallic layer 901 and liquid barrier 903 do not block tag 902 from being read by a NFC tag reader 905 placed below cap 904 and a person may claim ownership of the container.

FIG. 10 illustrates an exemplary dual public/private tag for use within a beverage cap, in accordance with an embodiment of the present invention. In the present embodiment, a dual public/private tag 1000 may include a public anti-metal tag 1001, a metallic layer 1002, an anti-metal private tag 1003, and a liquid barrier 1004 for tag protection and FDA approval. Typically, during manufacture of a cap 1005, public tag 1001 is inserted then thin metallic foil layer 1002 may be applied, followed by private tag 1003 and usually followed by a protective liquid barrier 1004. Cap 1005 may contain barrier 1004 to protect tags 1001 and 1003 from liquid in a container 1006 that could damage their electrical components. In some alternate embodiments, public tag 1001, metallic layer 1002, and private tag 1003 may be encased in a liquid barrier and then joined to the inside of cap 1005. In some other alternate embodiments, public tag 1001 and private tag 1003 each may be encased in a liquid barrier and then joined with metallic layer 1003 inside of cap 1005. In the present embodiment, public tag 1001 may be read from the outside of cap 1005. In the present embodiment, private tag 1003 may not be read from the outside until cap 1005 is removed from container 1006. Metallic layer 1002 may prevent a NFC tag reader from reading public tag 1001 while reading the private tag 1003 from the bottom of cap 1005.

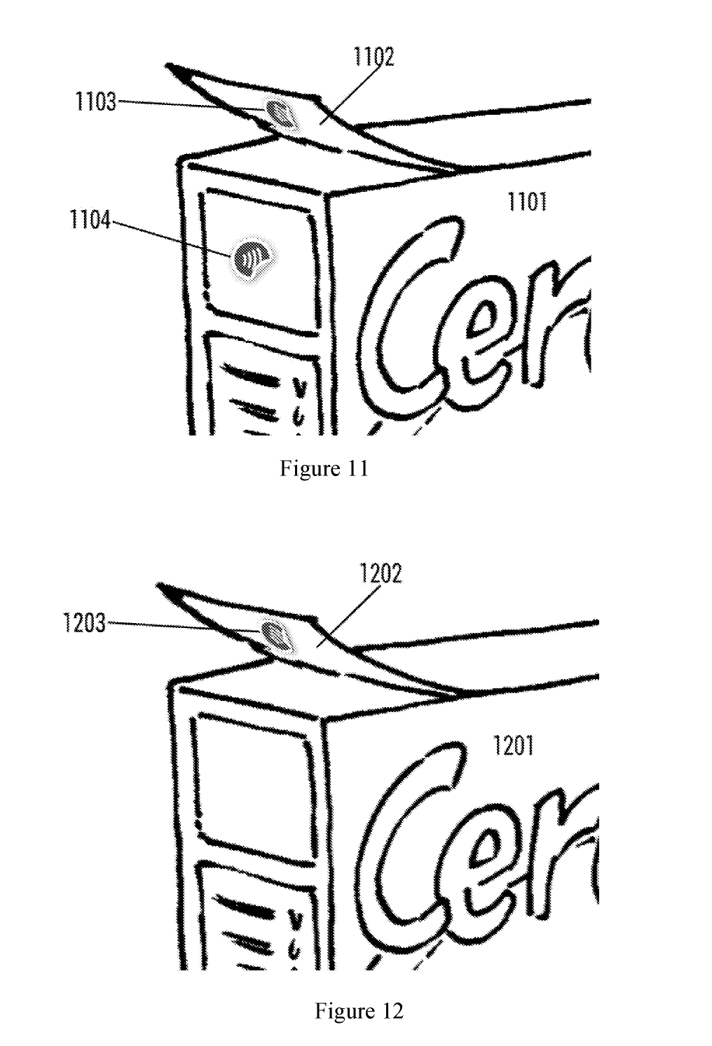

FIG. 11 illustrates an exemplary public tag and private tag for use with a packaged product, in accordance with an embodiment of the present invention. In the present embodiment, a packaged product box 1101 with a lid 1102 may have a private anti-metal tag 1103 under lid 1002 and a public tag 1104 on an outside surface of box 1101. This shows a non-limiting example of applying a private tag hidden within a package and optional public tag on the outside. It will be readily apparent to one of ordinary skill that the present embodiment may be applied to almost any product with external packaging such as, without limitation, appliances, dishware, TV dinners, meats, butter, bread packages, dry goods, etc. In some alternate embodiments, private anti-metal tag 1103 may not be attached to the package and placed within the package, or even to the inner product itself.

FIG. 12 illustrates an exemplary dual public/private tag for use with a packaged product, in accordance with an embodiment of the present invention. In the present embodiment, a packaged product box 1201 with a lid 1202 may have a dual public/private anti-metal tag 1203 may include a public anti-metal tag, and a private anti-metal tag. The present embodiment may allow customers to scan the public tag from the outside of the packaging 1201, while being unable to read the private tag from the outside. When the package is opened, the private tag becomes exposed and able to be read. As a non-limiting example, because the public tag may be hidden inside the packaging, a manufacturer may simply print an indication on the outside to let consumers know where to tap. Once a consumer obtains and opens the package, they may read the private tag and may be considered the product's new owner.

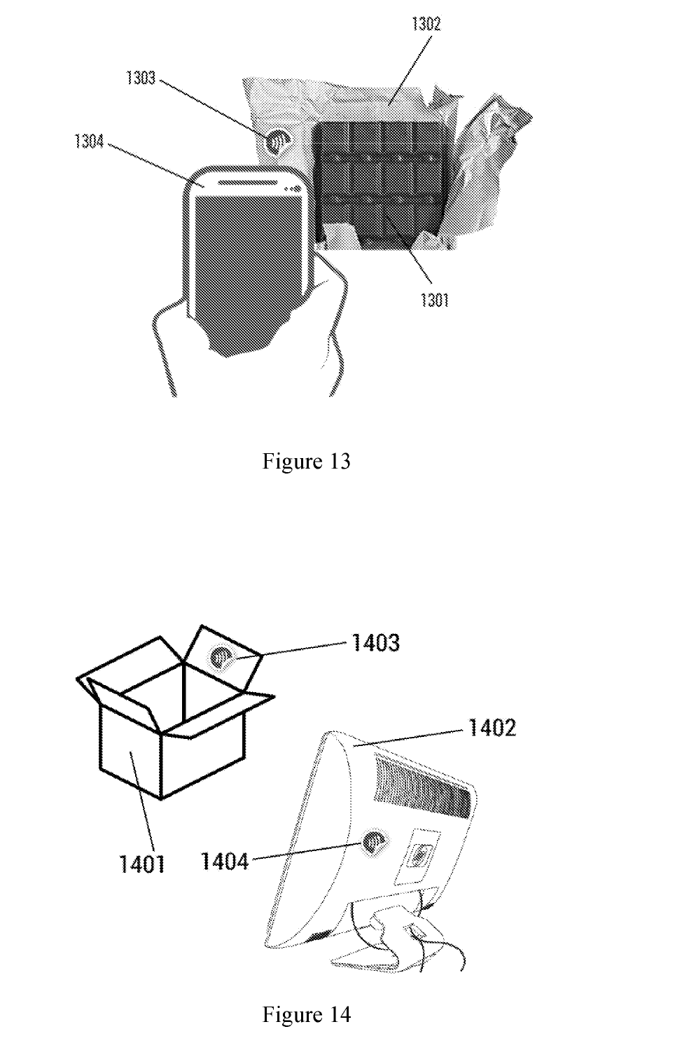

FIG. 13 illustrates an exemplary private anti-metal tag in use with a thin product, in accordance with an embodiment of the present invention. In the present embodiment, a thin product 1301 such as, but not limited to, a candy bar, may place a private anti-metal tag 1303 with thin product 1301 under wrapper 1302. In some cases, a potential issue with using tag configurations may be that if the product and/or packaging is thin enough, it may be possible to accidentally read private anti-metal tag 1303 from the opposite side of a package, which may be undesirable when using it to positively determine the owner. In a non-limiting example, a bar of chocolate may be less than 1 cm thick and cause this problem. In embodiments where wrapper 1302 is fully metallic, a private tag 1303 may only be read with NFC tag reader 1304 once the product is unwrapped to expose the open face of private tag 1303. Referring to FIG. 3, in embodiments where wrapper 1302 is not metallic, then an additional metallic layer 302 may be placed on the packaging side of tag 301 and a metallic patch on the opposite side 304 of the packaging and product 303 to prevent the tag 301 from being read prematurely until opened. In other embodiments, a public tag may be added, see FIG. 4. All of the same elements may apply such as, without limitation, adhesive layer 401, public tag 405, and opposite metallic layer 406. If the configuration is placed inside wrapper 1302, reading the public tag 402 may only work if the surrounding wrapper 1302 is non-metallic.

FIG. 14 illustrates an exemplary public tag and private tag in use with a packaged product, in accordance with an embodiment of the present invention. In the present embodiment, packaging 1401, public tag or dual public/private anti-metal tag 1403. Inner product 1402 may have an anti-metal private tag 1404. In the present embodiment, an appliance 1402 may be placed in a box 1401 and its private tag 1404 may be scanned only after it's opened, but the tag is applied to the product itself. In some embodiments, public tag 1403 may be affixed to packaging 1401, which may be placed outside or inside packaging 1401. In some embodiment, a dual public/private tag may be substituted for tag 1403 that would obviate the need for private tag 1404.

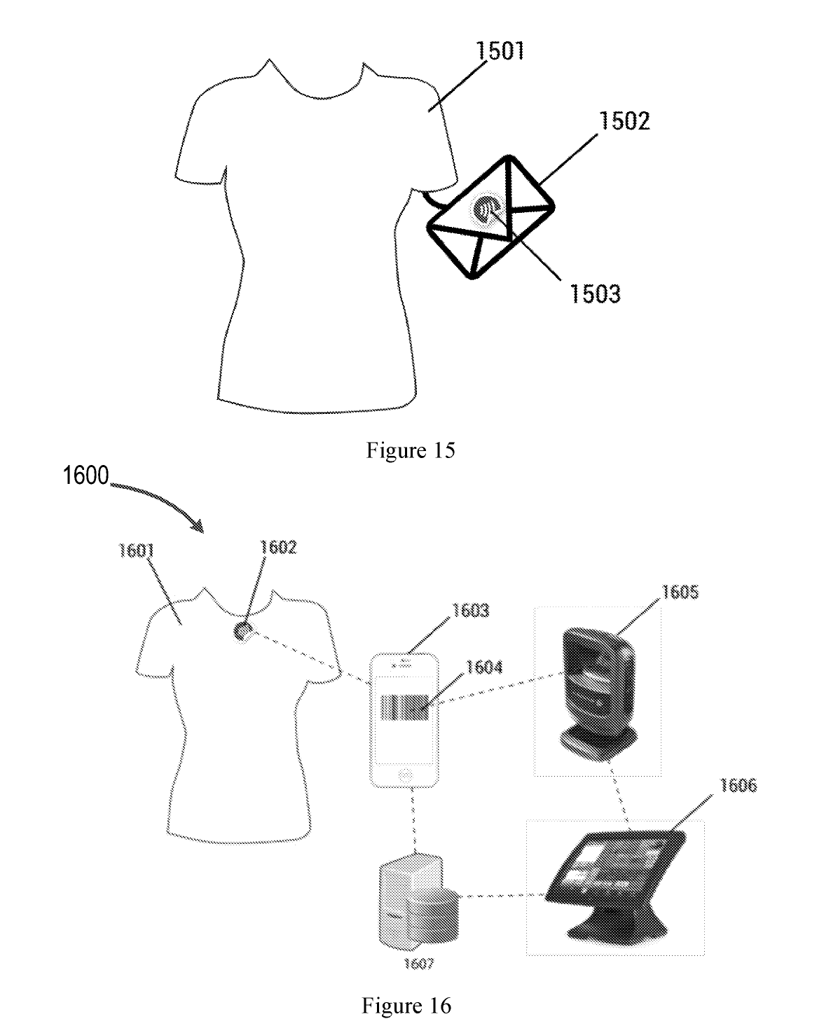

FIG. 15 illustrates an exemplary private tag in use with a protective envelope, in accordance with an embodiment of the present invention. In the present embodiment, a protective envelope 1502 may include a private anti-metal tag 1503 attached to a product 1501. Product 1501 may be any product that does not require packaging such as, but not limited to, clothing. Referring to FIG. 5, in the present embodiment, private anti-metal tag 1503 may not be read until removed from protective envelope 1502.

FIG. 16 illustrates an exemplary tag verification system, in accordance with an embodiment of the present invention. System 1600 may include a product 1601, a public tag 1602, a NFC tag reader 1603, an optical code reader 1605, a point of sale (POS) device 1606, and a server system 1607. In the present embodiment, a customer may choose product 1601 that may have public tag 1602 attached. NFC tag reader 1603 may then communicate information read from public tag 1602 and customer information to server system 1607. Server system 1607 may then communicate at least one coupon code 1604 to NFC tag reader 1603 for display. Optical code reader 1605 may read coupon code 1604 and communicate information to POS device 1606. POS device 1606 may communicate information to server system 1607 where a product purchase loop is closed and owner of product 1601 is verified. In the present embodiment, coupon code 1604 may be any scannable type of code, usually a QR code or barcode. Coupon codes today typically encode scant information such as product SKU, offer code, and discount type and/or amount. More advanced codes may contain an expiration date. or be rolling such that they are on valid for a short period of time to reduce fraud potential. Codes offered customers are generally not unique codes that might serve to create a single use coupon to limit fraud; POS terminals and their operating systems vary in capability and do not communicate directly to manufacturers' servers for validation. In a non-limiting example, a customer wishes to purchase shirt 1601 that has public tag 1602. In some embodiments, public tag 1602 may be waterproof and woven into the fabric. The customer may then tap public tag 1602 with their NFC enabled phone tag reader 1603. Tapping this public tag 1602 with phone 1603 may cause a launched app to send the tag 1602 ID and user ID to server 1607. A server 1607 may reply to phone 1603 with a coupon whose barcode 1604 may be displayed on the phone's screen. The cashier may scan barcode 1604 using barcode scanner 1605 connected to POS 1606. Barcode 1604 may be unique and tied to the tag's 1602 ID, user ID, and short-term session, perhaps lasting one hour. POS 1606 transmits barcode 1604 back to server 1607 and the product purchase loop is closed and owner verified. Tag 1602 may become a private tag locked to the owner of the product. The above non-limiting example may thwart malicious customers who may steal a private tag such as, without limitation, private tag 1503 in envelope 1502. In some alternate embodiments, if POS 1606 is NFC enabled barcode scanner may not be needed and the customer may tap POS 1606 with their phone 1603 to complete the purchase and verification.

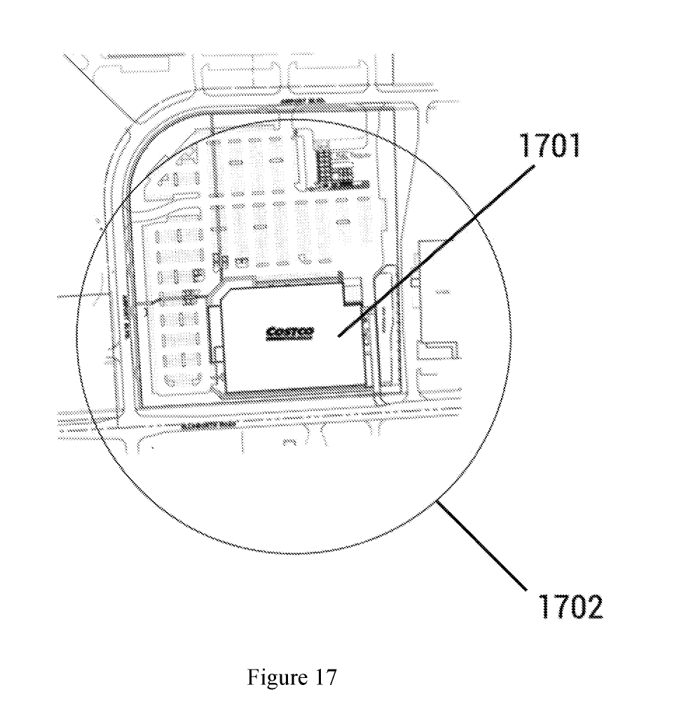

FIG. 17 illustrates an exemplary geo-tapping tags for determining ownership, in accordance with an embodiment of the present invention. In the present embodiment, a retail store or service center 1701 may have a configurable perimeter boundary 1702 within which scanned tags are considered public, outside of which are considered private. Ownership of a product may be determined by a location where a user taps a public tag on the product. If a consumer taps a product tag at retail store 1701 within a defined external perimeter 1702, then it may be considered to be a public tag and unowned by a customer. Once the consumer buys the product, leaves the store and taps on the same tag outside the same perimeter, then the tag may be considered a private tag, thus determining the new owner of the product. In a non-limiting example, the GPS coordinates of the store may be associated with the tags of all products shipped to this store. Typically, inventory control systems may already track where products are shipped. NFC tags may be programmed with a unique ID associated with their products and with a store in which they will be sold, and thus associated with the GPS location of the store. In some embodiments, it may also be possible to receive electronic shipping notification that confirms arrival of these shipments. Once they arrive, they may be activated for consumer tapping.

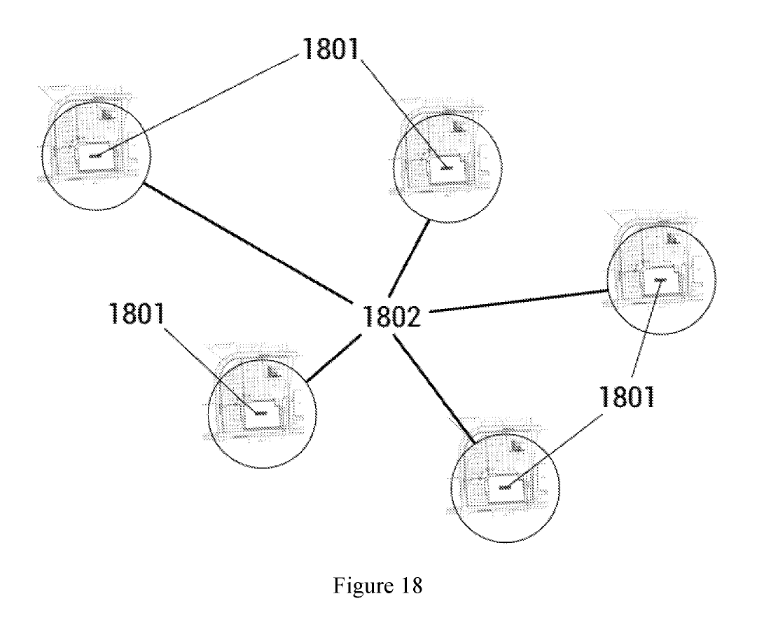

FIG. 18 illustrates an exemplary geo-tapping tag scenario at multiple locations for determining ownership, in accordance with an embodiment of the present invention. In the present embodiment, a retail store or service center 1801 may have multiple locations with configurable perimeter boundaries 1802 within which scanned tags are considered public, outside of which are considered private. In the present embodiment, a store chain may wish to internally redistribute a product between stores. In a non-limiting example, a store may wish to transfer tagged products to one or more different stores because some are running low on this product. In the present embodiment, a server may consider product tags private when the consumer taps outside of all store boundaries 1802 where the product is sold. In some embodiments, store management may inform the server when product is about to be shipped and when it arrives at its new store location to prevent unauthorized tapping during transit.

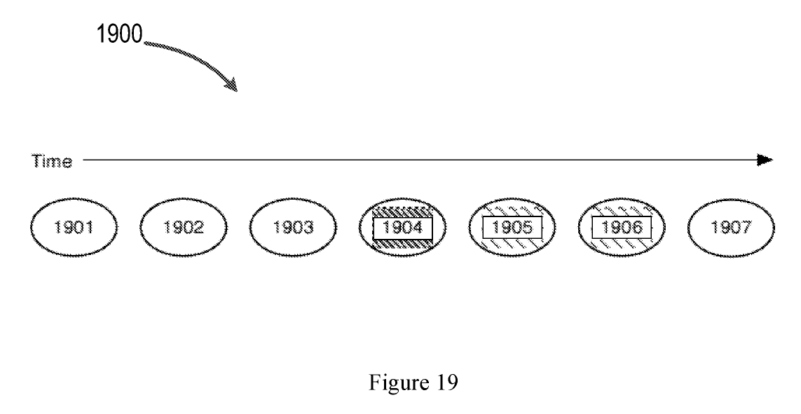

FIG. 19 illustrates an exemplary time line of customers tapping tags on a given product, in accordance with an embodiment of the present invention. In the present embodiment, when a product is awaiting purchase, possibly sitting on a store shelf, customers 1901, 1902 and 1903 may walk by and tap its public tag on the outside of its package. A server, not shown, may respond by treating these customers as non-owners and perhaps sending them a brief survey, promotions, etc. When a customer finally purchases the product 1904, the buyer may open the product and tap its private tag 1905 thereby becoming its first owner. Since the buyer was the first person to tap the private tag, the server may consider him to be the owner, responding with surveys, promotions, etc. but possibly extra special promotions that only owners receive. After the buyer claims ownership, anyone else tapping the private tag in the future would be treated as though they tapped an associated public tag, and only receive public content, just as previous public customers 1901-1903 did. In the present embodiment, a product manufacturer may choose to set the private tag's owner group size to be greater than one, allowing more than one person to co-own a specific product instance. This might be desirable for products that might be shared. In a non-limiting example, suppose the owner group size has been set to three for this product type; once a buyer has claimed ownership after tapping the private tag, his spouse 1905 and daughter 1906 taps the private tag and are now considered co-owners. Since the ownership group is now full, when a neighbor 1907 comes along and taps the private tag, the tag has reverted to behave as a public tag for him and future tappers.

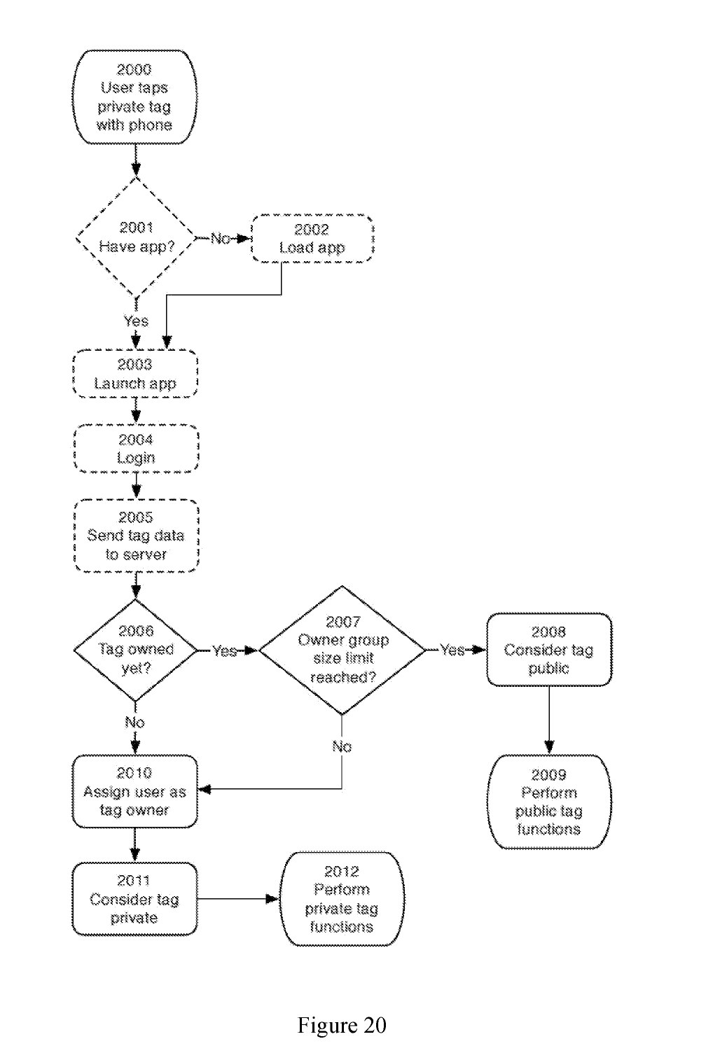

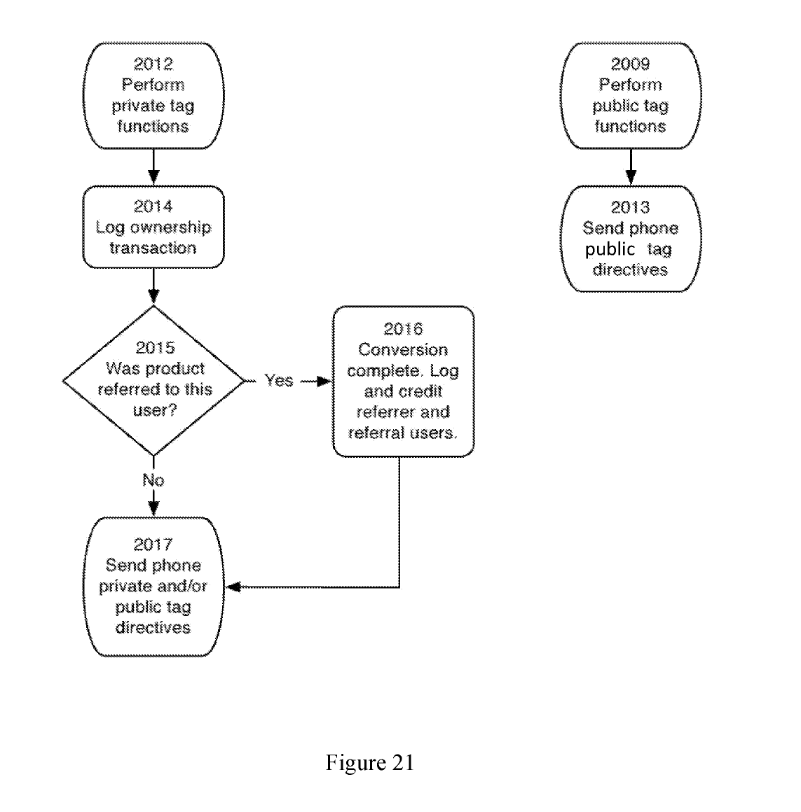

FIG. 20 and FIG. 21 illustrate an exemplary method for tapping a tag for a product, in accordance with an embodiment of the present invention. In a step 2000 a user taps a private tag a NFC enabled device such as, without limitation, a smartphone, tablet, etc. Tags may be programmed with industry standard NFC Data Exchange Format (NDEF) record(s) that may tell the smartphone operating system (OS) which application may be installed or launched when tapped in a step 2001. If the desired app to handle the tag is not installed in a step 2002, the smartphone OS will attempt to install it automatically with user permission and then launch the app. If the app is already installed in a step 2003, it will be launched to handle this tag type. A native app need not be installed and steps 2001 to 2003 may alternately launch a web app in the browser of user's device. The type of tag may be private to the manufacturer because of its unique package identifier within the NDEF record. The smartphone app may establish a connection and log the user in a step 2004 with a server. The user logs in and the app sends the server the tag ID and the user's ID such as, but not limited to, an email address, phone number, unique device ID or combination, etc. in a step 2005. The server may log the tap event in its database with the tap's timestamp, tag ID and other information. The server may check if this specific tag already has an assigned owner in a step 2006. In a step 2007, if owner(s) already exist for the private tag, the system still may accept additional owners and proceeds to a step 2010. If the product configuration no longer permits assigning this user as an owner, it may treat the tag as if it were a public tag in a step 2008 and offer the user benefits of such in a step 2009. In a step 2013 the server may send appropriate directives to the user's smartphone for a prospective product owner, perhaps in the form of content sections for display, including but not limited to product information, videos, recipe ideas, user manual, cross promotional and upsell products, solicitation for reorder subscription, quick poll, referral links, coupon and rebate offers, reviews, wish list, rewards and prizes. Otherwise, the system may assign the user as being the first or follow-on owners of the tag in a step 2010. In a step 2011 the user may be treated as an owner who tapped a private tag, and number of events may be triggered in a step 2012. The server may log the ownership detection with additional useful information such as, but not limited to, user id, tag id, timestamp, various sensor data, and GPS location if available. The server may check if someone referred this product to this customer in a step 2015 and close conversion loops in a step 2016 if that is the case. Closing a referral loop generally means that a referrer was successful at converting a referral into a buyer or newly acquired customer. Closing a conversion loop generally means that an ad or offer was successful in converting a consumer into a buyer. In a step 2017 the server may send to the new owner's smartphone content and instructions, which may include content also intended for public tappers of step 2013.

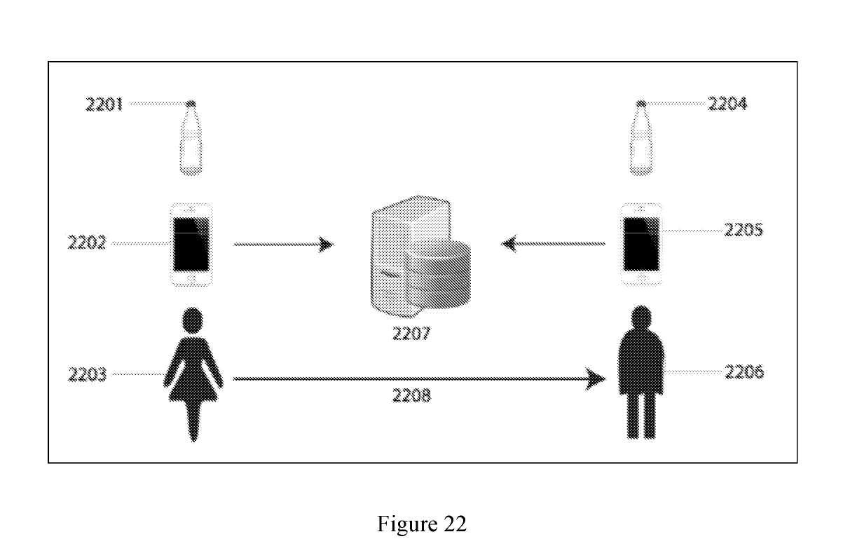

FIG. 22 illustrates an exemplary diagram of customers tapping tags on a given product, in accordance with an embodiment of the present invention. In the present embodiment, a loyalty-rewards system may be employed. In some embodiments, points may be awarded to the referrer and/or referral user. In some embodiments, coupons may be issued to one or both for future purchases. In some embodiments, an electronic coupon may be sent to the new owner that is viewable on their phone/device 2202 that may be immediately redeemable once a private tag is read. After a customer 2203 has tapped the unique private tag in a water bottle cap 2201 and communicated to server 2207, they may refer 2208 that product to one or more friends 2206 using various methods such as, without limitation, social networks, email, SMS and posting unique links on their blog or website. When a referral customer 2206 purchases a new water bottle 2204 and removes its cap, and reads its unique private tag with his phone 2205, server 2207 assigns him to be the owner of this newly purchased water. Server 2207 finds that the new customer 2206 was referred by referrer 2203 and closes the conversion loop, making this referral successfully referred, valuable for any viral marketing and advertising campaign.

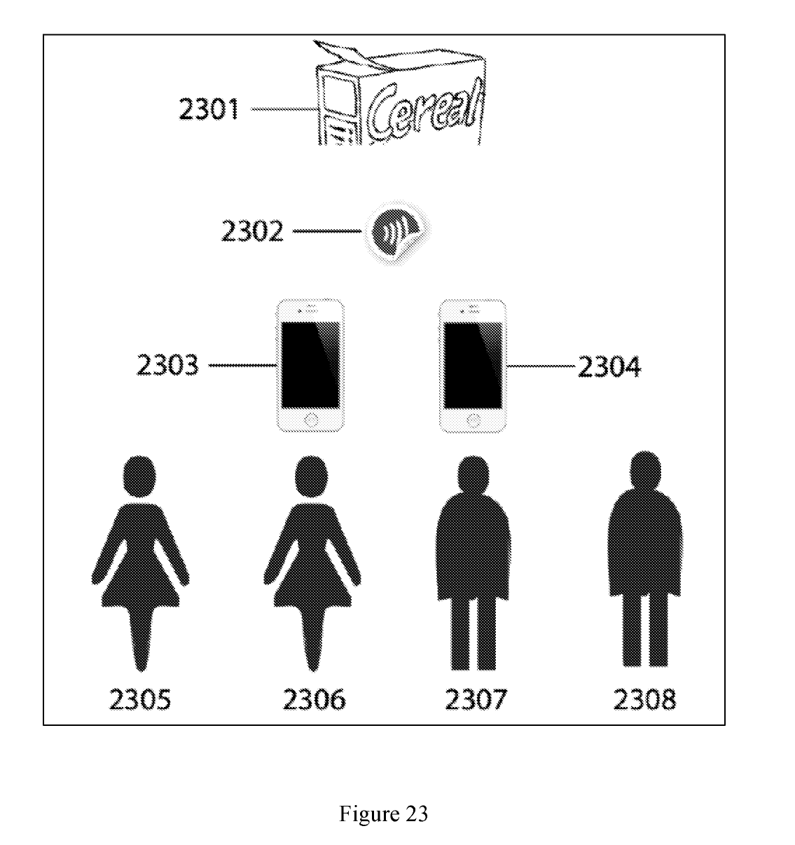

FIG. 23 illustrates an exemplary diagram of multiple product referrals, in accordance with an embodiment of the present invention. In the present embodiment, in a non-limiting example, Betty 2305 may refer a cereal 2301 to Judy 2306, and Tom 2308 may refer same cereal 2301 to Jim 2307. Jim may tap private tag 2302 with his phone 2304 and may become a primary owner. Judy 2306 may tap tag 2302 second with her phone 2303 and may become a secondary owner. Conversions for Betty 2305 and Tom 2308 may be completed. In a non-limiting example, if Betty 2305 refers cereal 2301 to her friend Judy 2306, Judy may ask her mother to buy it at the store. When her mother brings it home, Judy's father, Jim 2307, happens to open the cereal first and taps its private tag 2302 first, not realizing or caring that Betty 2305 referred the purchase of the cereal box 2301. The server (not shown) may now consider Jim 2307 to be the primary owner. However, cereal is also a communal product, i.e., multiple people can eat from the same box. It may be also possible that the first several people who tap its private tag 2302 actually contributed to the purchase of the cereal as well or simply ate some. Judy 2306 taps second after her Jim 2307 and may be considered its second owner. It may be reasonable to conclude that Betty's 2305 referral to Judy 2306 may now be complete because Judy did not just tap on the cereal's public tag (not shown) but on its private tag 2302 under the lid after Jim 2307 did. The cereal may have been a gift, but for the purpose of conversion tracking, someone paid for the cereal and transferred ownership to Judy's family. In another non-limiting example, it might be possible that Tom 2308 also referred the cereal 2301 to Jim 2307 before Judy's mother bought it. Tom's referral loop may also be closed. The present embodiment may not make a distinction between whether both Betty 2305 and Tom 2308 receive credit for conversions or not. A manufacturer may tune a product's owner group size depending its share factor. For the purpose of conversion tracking, some products such as, without limitation, cereal or TVs may be sharable among four or more people, for example, without limitation, while a water bottle may have an owner group size of one and may not be shareable.

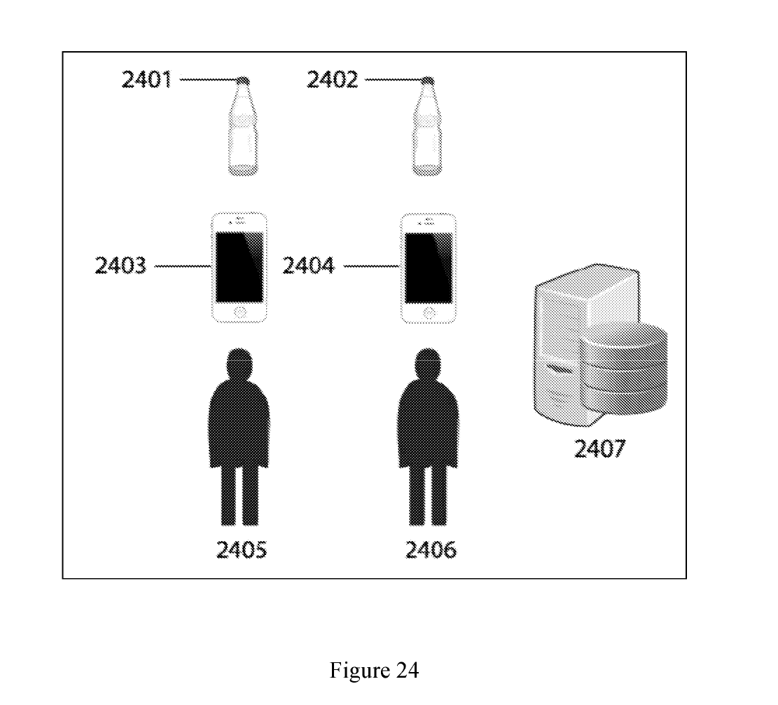

FIG. 24 illustrates an exemplary diagram of mitigating product referral abuse, in accordance with an embodiment of the present invention. In the present example of an embodiment, Tom 2405 may purchase a bottle of water 2401, opens its cap and may read its private tag. He may become its owner. Tom 2405 may now decide to refer the water to Jim 2406. If Jim is with Tom, Jim may attempt to tap Tom's bottle's private tag 2401 in hopes of getting rewarded without having to buy his own bottle. The server 2407 denies this referral conversion because not only does the water have an owner group size of one, for example, but Jim 2406 tapped the very same private tag 2401 that Tom 2405 used to refer to Jim 2406. Jim must purchase his own bottle of water 2402 and read with his phone 2404 to get conversion credit and close Tom's referral loop.

Referring to FIG. 23, the same situation may applies to Judy 2306 if she tries to tap the same private tag that Betty 2305 used to refer to her. Judy may have to purchase her own cereal box 2301 with a unique private tag for a valid conversion and ownership consideration, even though the cereal's conversion group size may be greater than one.

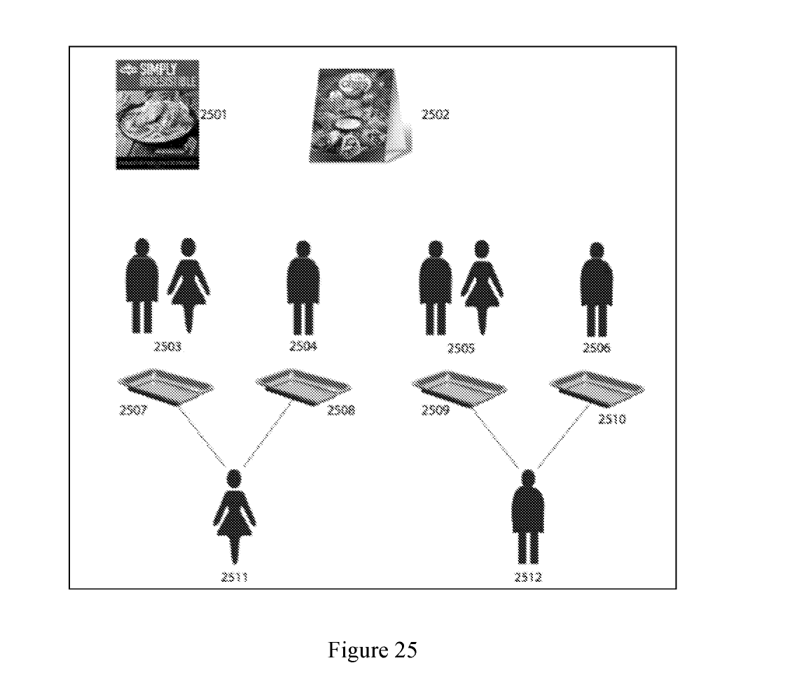

FIG. 25 illustrates an exemplary diagram of service ownership and conversion in a restaurant/service environment, in accordance with an embodiment of the present invention. The present example of an embodiment, may include waiters 2511 and 2512, trays 2507-2510 with private tag cards accompanying guest checks at time of payment, customers 2503-2506, public tags on posters 2501 and table tents 2502. In the present embodiment, a restaurant may have public tag posters 2501 hanging in windows and other locations as well as public tag table tents 2502 sitting on tables and at bars. Those tags may be considered public because they may not be presented directly at time or point of purchase. They may have value, but may not help identify paying customers of the restaurant. At time of payment, a waitress or bartender 2511 may present her customer 2503 with private tag post card on trays 2507 that accompanies their guest check. In a sense, the customer may become the owner of the waiter's service and restaurant's food and drink at that time. These tag cards may be public/private hybrids because they may be substantially reusable in a confined, limited space but only available for short periods of time. The owner group size of these private tags may be substantial. They may have numerous owners during their lifetimes separated by time between windows where the waiter presents the bill. Each tag may have a globally unique ID, mapped to individual waiters. This may allow a waiter to have multiple unique tag cards with which to hand customers when several are paying at once. Waitress 2511 may present customer 2504 with another tray 2508 with tag card. Another waiter 2512 presents his own trays 2509 and 2510 to customers 2505 and 2506. When waiter 2512 may quit his job at the restaurant sometime in the future, a manager may easily reassign his tags to a new waiter taking his place. The tag cards may not be allowed to stray outside the restaurant or be left out for non-paying customers to tap since the point of these tags may be to be used at point of purchase. Management may need to ensure they are returned at the end of a waiter's shift. It may be expected that businesses are self-incented to control these tags since they may want to collect accurate customer feedback regarding their staff. If one or more do go missing, they may invalidate a waiter's old set of tags and use or order a new set.

When customers see and tap their tag cards while paying their bills the name and photo of their waiter may appear on their phone from the app that tapped their tag card so the customer may verify they are providing feedback for the correct waiter. In some embodiments, one or more customers per table may tap the same tag card and may close one or more potential conversion loops since this event may be considered a time of ownership if the bill is being paid. In some embodiment, if one or more customers at the table have an electronic coupon, they may present it to their waiter at that time for applicable discount as well. In some embodiments, customers may provide instant feedback with a small number of questions with rating answers, for example, without limitation, to keep interaction brief. Ideally this may a good time to also, without limitation, ask customers to refer their friends to earn rewards, win prizes for participating, and receive other benefits, possibly discounts at this restaurant chain.

After a customer pays his bill, the waiter may retrieve his tag card and may now be free to present it to other paying customers. Since these tag cards may be assigned to specific waiters as well as the restaurant as a whole, any feedback retrieved from customers may be linked to their waiter. This may allow restaurant managers to continuously evaluate staff performance in real-time. In some embodiments, they may take immediate action potentially to rectify poor customer experiences by contacting customers unobtrusively through the app.

Other embodiments may be for use in quick service restaurants as well where guest checks may not be delivered to tables. In this case, cashiers may present their private tag card at the cash register they are manning. Doing so may not hold up the line very long because the act of tapping simply installs or launches an appropriate app for the tag. The user may interact with the app after he has paid and left the register. The placement and use case of tags at registers may strongly link tags to time and point of purchase, making them essentially private tags even though numerous patrons may be passing through the line and tapping them as well. Its owner group size may be substantial.

In other embodiments, ownership of services may be extended to almost unlimited number of contexts, for example, without limitation, spas, pet groomers, auto service, handymen, plumbers, hospitals, clinics, hair stylists, cleaners, pest service, cabs, buses, airports, and more. All may need a secure presentation of NFC tags by staff for feedback and viral marketing, which may mean the staff present one private tag per paying customer at check out, and possibly activating a tag by tapping it with the sales clerk's phone with administrative account to further secure the private tag.

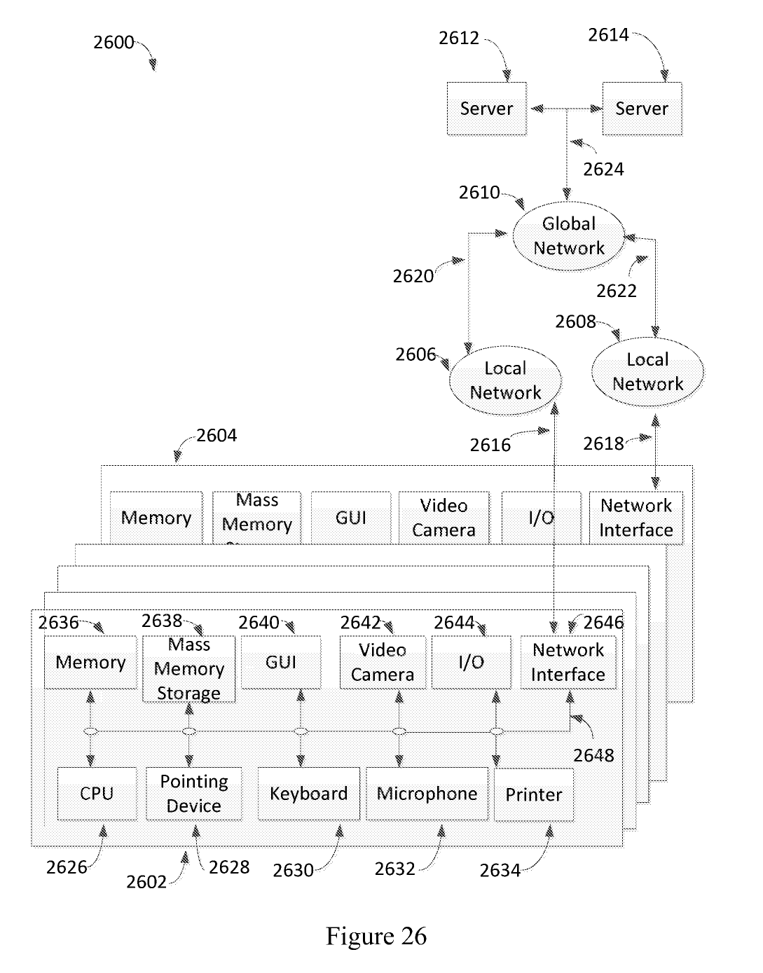

FIG. 26 is a block diagram depicting an exemplary client/server system that may be used by an exemplary web-enabled/networked embodiment of the present invention.

A communication system 2600 includes a multiplicity of clients with a sampling of clients denoted as a client 2602 and a client 2604, a multiplicity of local networks with a sampling of networks denoted as a local network 2606 and a local network 2608, a global network 2610 and a multiplicity of servers with a sampling of servers denoted as a server 2612 and a server 2614.

Client 2602 may communicate bi-directionally with local network 2606 via a communication channel 2616. Client 2604 may communicate bi-directionally with local network 2608 via a communication channel 2618. Local network 2606 may communicate bi-directionally with global network 2610 via a communication channel 2620. Local network 2608 may communicate bi-directionally with global network 2610 via a communication channel 2622. Global network 2610 may communicate bi-directionally with server 2612 and server 2614 via a communication channel 2624. Server 2612 and server 2614 may communicate bi-directionally with each other via communication channel 2624. Furthermore, clients 2602, 2604, local networks 2606, 2608, global network 2610 and servers 2612, 2614 may each communicate bi-directionally with each other.

In one embodiment, global network 2610 may operate as the Internet. It will be understood by those skilled in the art that communication system 2600 may take many different forms. Non-limiting examples of forms for communication system 2600 include local area networks (LANs), wide area networks (WANs), wired telephone networks, wireless networks, or any other network supporting data communication between respective entities.

Clients 2602 and 2604 may take many different forms. Non-limiting examples of clients 2602 and 2604 include personal computers, personal digital assistants (PDAs), cellular phones and smartphones.

Client 2602 includes a CPU 2626, a pointing device 2628, a keyboard 2630, a microphone 2632, a printer 2634, a memory 2636, a mass memory storage 2638, a GUI 2640, a video camera 2642, an input/output interface 2644 and a network interface 2646.

CPU 2626, pointing device 2628, keyboard 2630, microphone 2632, printer 2634, memory 2636, mass memory storage 2638, GUI 2640, video camera 2642, input/output interface 2644 and network interface 2646 may communicate in a unidirectional manner or a bi-directional manner with each other via a communication channel 2648. Communication channel 2648 may be configured as a single communication channel or a multiplicity of communication channels.

CPU 2626 may be comprised of a single processor or multiple processors. CPU 2626 may be of various types including micro-controllers (e.g., with embedded RAM/ROM) and microprocessors such as programmable devices (e.g., RISC or SISC based, or CPLDs and FPGAs) and devices not capable of being programmed such as gate array ASICs (Application Specific Integrated Circuits) or general purpose microprocessors.

As is well known in the art, memory 2636 is used typically to transfer data and instructions to CPU 2626 in a bi-directional manner. Memory 2636, as discussed previously, may include any suitable computer-readable media, intended for data storage, such as those described above excluding any wired or wireless transmissions unless specifically noted. Mass memory storage 2638 may also be coupled bi-directionally to CPU 2626 and provides additional data storage capacity and may include any of the computer-readable media described above. Mass memory storage 2638 may be used to store programs, data and the like and is typically a secondary storage medium such as a hard disk. It will be appreciated that the information retained within mass memory storage 2638, may, in appropriate cases, be incorporated in standard fashion as part of memory 2636 as virtual memory.

CPU 2626 may be coupled to GUI 2640. GUI 2640 enables a user to view the operation of computer operating system and software. CPU 2626 may be coupled to pointing device 2628. Non-limiting examples of pointing device 2628 include computer mouse, trackball and touchpad. Pointing device 2628 enables a user with the capability to maneuver a computer cursor about the viewing area of GUI 2640 and select areas or features in the viewing area of GUI 2640. CPU 2626 may be coupled to keyboard 2630. Keyboard 2630 enables a user with the capability to input alphanumeric textual information to CPU 2626. CPU 2626 may be coupled to microphone 2632. Microphone 2632 enables audio produced by a user to be recorded, processed and communicated by CPU 2626. CPU 2626 may be connected to printer 2634. Printer 2634 enables a user with the capability to print information to a sheet of paper. CPU 2626 may be connected to video camera 2642. Video camera 2642 enables video produced or captured by user to be recorded, processed and communicated by CPU 2626.

CPU 2626 may also be coupled to input/output interface 2644 that connects to one or more input/output devices such as such as CD-ROM, video monitors, track balls, mice, keyboards, microphones, touch-sensitive displays, transducer card readers, magnetic or paper tape readers, tablets, styluses, voice or handwriting recognizers, or other well-known input devices such as, of course, other computers.

Finally, CPU 2626 optionally may be coupled to network interface 2646 which enables communication with an external device such as a database or a computer or telecommunications or internet network using an external connection shown generally as communication channel 2616, which may be implemented as a hardwired or wireless communications link using suitable conventional technologies. With such a connection, CPU 2626 might receive information from the network, or might output information to a network in the course of performing the method steps described in the teachings of the present invention.

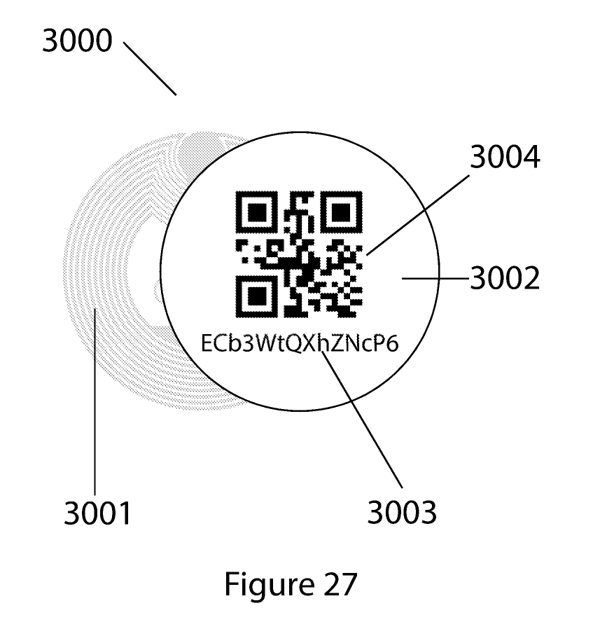

FIG. 27 shows an example of a single tag 3000 that may contain an NFC tag 3001 with additional, optional forms of identification that can be retrieved in lieu of an NFC reader, including a printed sticker 3002 with QR code 3004 and serial number 3003. The QR code 3004 (barcode) may be scanned by a mobile scanner app. A serial number 3003 may be scanned electronically or entered by hand into a mobile device app's text form. This is useful for people who do not have a smartphone with an NFC reader; they can scan the QR code with their phone's camera, or if they don't have a camera may manually enter the serial number into a form.

In other embodiments, QR Codes may also be used to determine product ownership when they are made private. That is, like NFC tags, they may be placed within packaging, on products within packaging, within opaque envelopes and so on, as long as they may not be scanned until after purchased/received and opened. If they are scanned on the outside of a package, there may be no way to determine product ownership using QR Codes by themselves.

Further, QR Codes are not the only form of barcode that may be used. In other embodiments, any type of barcode or unique graphic may be used to uniquely identify a specific product instance (not just a product type), as long as the barcode may sufficiently represent at least as many unique ID's as products manufactured with it applied, and ideally a much larger ID space to avoid fraud.

While QR Codes and barcodes may be printed on receipts today, they are most likely the same codes printed on every receipt. They might take the user to a generic survey or receive a generic coupon. Other embodiments of the present invention may call for printing a unique code per receipt to uniquely link a purchase with a customer, not any customer. A unique code may, without limitation, allow a system to determine unique ownership of a transaction or service, and perform conversion tracking, coupon redemption, etc.

Other embodiments of the present invention may print unique serial numbers on receipts or within packaging in lieu of tags or QR Codes. Instead of a user tapping a tag or scanning a QR Code, they may find and launch an app or website that may let them enter the code viewed into a form that may be verified with a server over a network.

In other embodiments of the present invention, a serial number may be configured with a limited life span for determining ownership. While serial numbers are typically used with software products to activate a license, these codes may be used to determine ownership and track conversions and redemptions for almost any conceivable product. Today there are certainly existing scratch-off gift cards that reveal a unique serial number, such as Apple's iTunes cards. These cards may only used to unlock a specific redemption cash value to be added to an account. Teachings of the present invention may extend this notion dramatically to all forms of packaging, determines ownership and uses ownership determination for much more than cash value redemption.

A user may not necessarily need to install and app or launch a website to enter a serial number. As a non-limiting example, Google's voice search makes it possible to define a key phrase, such as “Redeem coupon number XJ532418AYW”. This may tell Android to launch a specific redemption app that may verify the code without requiring the user to type it into a form.

In other embodiments, teachings of the present invention may be applied to physical mail whereby a private tag is placed within a sealed envelope and once opened by a recipient, they may tap the private tag with their smartphone and connect with the sender, letting them know they opened the package, not simply received it as carriers may report today, receiving digital content on their device or initiating a desired experience. Without this, feedback loop, some percentage of postage could simply be thrown away and not read or considered.

In other embodiments, teachings of the present invention may be used for compliance. In a non-limiting example, in a pharmaceutical application, a doctor or insurance company could instruct the patient to take a pill each day of their prescription and tap the private tag to confirm. This may also serve to automate the refill of medication and also alert the doctor (or family members) in case the user is not taking their medication.

In other embodiments, teachings of the present invention may be used in a semi-inventory B2B scenario as well. In a non-limiting example, public/private tags may be placed on large supplies of food and beverages ordered by restaurant that are received and tracked in their back of house. Tapping the private tag within a bulk package may connects the manufacturer with the restaurateur. They may incentivize the owner with offers as well, get feedback and data. But the owner may also tap to track usage quite simply by tapping for each item removed from a package, and the distributor may be alerted to automatically ship a replacement on their next delivery if so set up by the business owner. An app may track contents of a specific container and dates used, so as not to accidentally tap too many times.

In other embodiments, private tags may be used in a hotel room or cruise ship cabin to, without limitation, let guest/renter tap to order room service, respond to customer surveys, order maid service, make reservations. The tags may be dynamically tied to the designated guests at check in so that only they and perhaps family members would be authorized to order service/products against their credit card on file from the room/cabin, as a proxy in lieu of actually making separate transactions.

Those skilled in the art will readily recognize, in light of and in accordance with the teachings of the present invention, that any of the foregoing steps and/or system modules may be suitably replaced, reordered, removed and additional steps and/or system modules may be inserted depending upon the needs of the particular application, and that the systems of the foregoing embodiments may be implemented using any of a wide variety of suitable processes and system modules, and is not limited to any particular computer hardware, software, middleware, firmware, microcode and the like. For any method steps described in the present application that can be carried out on a computing machine, a typical computer system can, when appropriately configured or designed, serve as a computer system in which those aspects of the invention may be embodied.

Those skilled in the art will readily recognize, in light of and in accordance with the teachings of the present invention, that any of the foregoing steps may be suitably replaced, reordered, removed and additional steps may be inserted depending upon the needs of the particular application. Moreover, the prescribed method steps of the foregoing embodiments may be implemented using any physical and/or hardware system that those skilled in the art will readily know is suitable in light of the foregoing teachings. For any method steps described in the present application that can be carried out on a computing machine, a typical computer system can, when appropriately configured or designed, serve as a computer system in which those aspects of the invention may be embodied. Thus, the present invention is not limited to any particular tangible means of implementation.

It will be further apparent to those skilled in the art that at least a portion of the novel method steps and/or system components of the present invention may be practiced and/or located in location(s) possibly outside the jurisdiction of the United States of America (USA), whereby it will be accordingly readily recognized that at least a subset of the novel method steps and/or system components in the foregoing embodiments must be practiced within the jurisdiction of the USA for the benefit of an entity therein or to achieve an object of the present invention. Thus, some alternate embodiments of the present invention may be configured to comprise a smaller subset of the foregoing means for and/or steps described that the applications designer will selectively decide, depending upon the practical considerations of the particular implementation, to carry out and/or locate within the jurisdiction of the USA. For example, any of the foregoing described method steps and/or system components which may be performed remotely over a network (e.g., without limitation, a remotely located server) may be performed and/or located outside of the jurisdiction of the USA while the remaining method steps and/or system components (e.g., without limitation, a locally located client) of the forgoing embodiments are typically required to be located/performed in the USA for practical considerations. In client-server architectures, a remotely located server typically generates and transmits required information to a US based client, for use according to the teachings of the present invention. Depending upon the needs of the particular application, it will be readily apparent to those skilled in the art, in light of the teachings of the present invention, which aspects of the present invention can or should be located locally and which can or should be located remotely. Thus, for any claims construction of the following claim limitations that are construed under 35 USC §112 (6) it is intended that the corresponding means for and/or steps for carrying out the claimed function are the ones that are locally implemented within the jurisdiction of the USA, while the remaining aspect(s) performed or located remotely outside the USA are not intended to be construed under 35 USC §112 (6). In some embodiments, the methods and/or system components which may be located and/or performed remotely include, without limitation: a complete system including server, local and global networks and connected client devices such as smartphones, tablets, desktop and laptop computers; the NFC tag manufacture, programming, delivery to remote product manufactures and retailers; creation of offer campaigns, product content for delivery, rewards programs, etc. There should be nothing that prevents a complete system from running independently outside the USA technically except for potential cultural and/or regulatory barriers.

It is noted that according to USA law, all claims must be set forth as a coherent, cooperating set of limitations that work in functional combination to achieve a useful result as a whole. Accordingly, for any claim having functional limitations interpreted under 35 USC §112 (6) where the embodiment in question is implemented as a client-server system with a remote server located outside of the USA, each such recited function is intended to mean the function of combining, in a logical manner, the information of that claim limitation with at least one other limitation of the claim. For example, in client-server systems where certain information claimed under 35 USC §112 (6) is/(are) dependent on one or more remote servers located outside the USA, it is intended that each such recited function under 35 USC §112 (6) is to be interpreted as the function of the local system receiving the remotely generated information required by a locally implemented claim limitation, wherein the structures and or steps which enable, and breathe life into the expression of such functions claimed under 35 USC §112 (6) are the corresponding steps and/or means located within the jurisdiction of the USA that receive and deliver that information to the client (e.g., without limitation, client-side processing and transmission networks in the USA). When this application is prosecuted or patented under a jurisdiction other than the USA, then “USA” in the foregoing should be replaced with the pertinent country or countries or legal organization(s) having enforceable patent infringement jurisdiction over the present application, and “35 USC §112 (6)” should be replaced with the closest corresponding statute in the patent laws of such pertinent country or countries or legal organization(s).

All the features disclosed in this specification, including any accompanying abstract and drawings, may be replaced by alternative features serving the same, equivalent or similar purpose, unless expressly stated otherwise. Thus, unless expressly stated otherwise, each feature disclosed is one example only of a generic series of equivalent or similar features.

It is noted that according to USA law 35 USC §112 (1), all claims must be supported by sufficient disclosure in the present patent specification, and any material known to those skilled in the art need not be explicitly disclosed. However, 35 USC §112 (6) requires that structures corresponding to functional limitations interpreted under 35 USC §112 (6) must be explicitly disclosed in the patent specification. Moreover, the USPTO's Examination policy of initially treating and searching prior art under the broadest interpretation of a “mean for” claim limitation implies that the broadest initial search on 112(6) functional limitation would have to be conducted to support a legally valid Examination on that USPTO policy for broadest interpretation of “mean for” claims. Accordingly, the USPTO will have discovered a multiplicity of prior art documents including disclosure of specific structures and elements which are suitable to act as corresponding structures to satisfy all functional limitations in the below claims that are interpreted under 35 USC §112 (6) when such corresponding structures are not explicitly disclosed in the foregoing patent specification. Therefore, for any invention element(s)/structure(s) corresponding to functional claim limitation(s), in the below claims interpreted under 35 USC §112 (6), which is/are not explicitly disclosed in the foregoing patent specification, yet do exist in the patent and/or non-patent documents found during the course of USPTO searching, Applicant(s) incorporate all such functionally corresponding structures and related enabling material herein by reference for the purpose of providing explicit structures that implement the functional means claimed. Applicant(s) request(s) that fact finders during any claims construction proceedings and/or examination of patent allowability properly identify and incorporate only the portions of each of these documents discovered during the broadest interpretation search of 35 USC §112 (6) limitation, which exist in at least one of the patent and/or non-patent documents found during the course of normal USPTO searching and or supplied to the USPTO during prosecution. Applicant(s) also incorporate by reference the bibliographic citation information to identify all such documents comprising functionally corresponding structures and related enabling material as listed in any PTO Form-892 or likewise any information disclosure statements (IDS) entered into the present patent application by the USPTO or Applicant(s) or any 3^{rd} parties. Applicant(s) also reserve its right to later amend the present application to explicitly include citations to such documents and/or explicitly include the functionally corresponding structures that were incorporate by reference above.

Thus, for any invention element(s)/structure(s) corresponding to functional claim limitation(s), in the below claims, that are interpreted under 35 USC §112 (6), which is/are not explicitly disclosed in the foregoing patent specification, Applicant(s) have explicitly prescribed which documents and material to include the otherwise missing disclosure, and have prescribed exactly which portions of such patent and/or non-patent documents should be incorporated by such reference for the purpose of satisfying the disclosure requirements of 35 USC §112 (6). Applicant(s) note that all the identified documents above which are incorporated by reference to satisfy 35 USC §112 (6) necessarily have a filing and/or publication date prior to that of the instant application, and thus are valid prior documents to incorporated by reference in the instant application.

Having fully described at least one embodiment of the present invention, other equivalent or alternative methods of implementing communications devices and related methods that use NFC according to the present invention will be apparent to those skilled in the art. Various aspects of the invention have been described above by way of illustration, and the specific embodiments disclosed are not intended to limit the invention to the particular forms disclosed. The particular implementation of the communications devices and related methods that use NFC may vary depending upon the particular context or application. By way of example, and not limitation, the communications devices and related methods that use NFC described in the foregoing were principally directed to NFC tag implementations; however, similar techniques may instead be applied to any coding system that identifies any tangible or non-tangible object, which implementations of the present invention are contemplated as within the scope of the present invention. The invention is thus to cover all modifications, equivalents, and alternatives falling within the spirit and scope of the following claims. It is to be further understood that not all of the disclosed embodiments in the foregoing specification will necessarily satisfy or achieve each of the objects, advantages, or improvements described in the foregoing specification.

Claim elements and steps herein may have been numbered and/or lettered solely as an aid in readability and understanding. Any such numbering and lettering in itself is not intended to and should not be taken to indicate the ordering of elements and/or steps in the claims.

The corresponding structures, materials, acts, and equivalents of all means or step plus function elements in the claims below are intended to include any structure, material, or act for performing the function in combination with other claimed elements as specifically claimed.

The corresponding structures, materials, acts, and equivalents of all means or step plus function elements in the claims below are intended to include any structure, material, or act for performing the function in combination with other claimed elements as specifically claimed. The description of the present invention has been presented for purposes of illustration and description, but is not intended to be exhaustive or limited to the invention in the form disclosed. Many modifications and variations will be apparent to those of ordinary skill in the art without departing from the scope and spirit of the invention. The embodiment was chosen and described in order to best explain the principles of the invention and the practical application, and to enable others of ordinary skill in the art to understand the invention for various embodiments with various modifications as are suited to the particular use contemplated.

The Abstract is provided to comply with 37 C.F.R. Section 1.72(b) requiring an abstract that will allow the reader to ascertain the nature and gist of the technical disclosure. That is, the Abstract is provided merely to introduce certain concepts and not to identify any key or essential features of the claimed subject matter. It is submitted with the understanding that it will not be used to limit or interpret the scope or meaning of the claims.

The following claims are hereby incorporated into the detailed description, with each claim standing on its own as a separate embodiment.

What is claimed is:

1. A system comprising:
a package, wherein said package is configured to enclose a product; and
a tag disposed in said package, wherein said tag being configured to identify, at least one of, an identifier of the product and a global instance of the product, and a name listed in a scanning device that accepted said package, in which said tag comprising;
an attaching means, wherein said attaching means is configured to attach said tag to a surface of said package;
an anti-metal private tag layer, said anti-metal private tag layer is disposed to face an inside of said package, wherein said anti-metal private tag layer is configured to prevent said tag from being tapped from an outside of said package; and
a metallic backing layer, wherein said metallic backing layer is disposed to shield said anti-metal private tag from tapping from the outside of said package.

2. The system of claim 1, wherein said package comprises a secure package sealed at a factory, said secure packaging is configured to prevent casual shoppers from opening said package pre-purchased and scanning said tag.

3. The system of claim 1, further comprising a second metallic shielding layer disposed to shield said anti-metal private tag layer from being tapped on the inside of said package.

4. The system of claim 3, wherein said second metallic shielding layer comprises a removable metallic shielding layer that is configured to be operable for removal upon receipt of said package for scanning.

5. The system of claim 1, wherein said metallic backing layer comprises a removable metallic backing layer, wherein a removal of said metallic backing layer is configured to allow said anti-metal private tag layer to be scanned and tapped on from the outside and inside of said package.

6. The system of claim 1, wherein said tag is a readable private tag, and wherein said private tag further comprising a printed code disposed to face the outside of said package, in which said printed QR code is configured to be operable for scanning in the absence of an NFC private tag reader or scanner.

7. The system of claim 1, wherein said tag is a readable private tag, and wherein said private tag further comprising a printed serial number disposed to face the outside of said package, in which said printed serial number is configured to be operable for entering into a form in the absence of a private tag reader.

8. The system of claim 1, further comprising a public tag layer disposed to face the outside of said package, wherein said public tag layer being operable for scanning from the outside of said package, and wherein said public tag layer is configured to contain a hash or encrypted content.

9. The system of claim 8, wherein said hash or encrypted content identify at least a product SKU and a unique identifier.

10. The system of claim 9, in which said scanning device comprising a tag reader that is configured to tap said public tag layer and said private tag layer, wherein said tag reader is configured to provide a timestamp, a tag content, GPS location, and a user ID of said name listed in said scanning device that accepted said package.

11. A system comprising:
a package, wherein said package is configured to enclose a product; and
a tag disposed in said package, said tag comprising;
an anti-metal private tag layer, wherein said anti-metal private tag layer is configured to identify, at least one of, an identifier of the product and a name listed in a reader device that accepted said package;
an anti-metal public tag layer, wherein said anti-metal public tag layer being disposed for scanning from an outside of said package, wherein said anti-metal public tag layer comprises a hash or encrypted content configured to identify at least a product SKU and a unique identifier; and
a metallic backing layer, wherein said metallic backing layer being disposed between said anti-metal private tag layer and said anti-metal public tag layer.

12. The system of claim 11, wherein said tag is disposed in, at least one of, a bottle cap lid, and box, wherein said package is at least one of, a water bottle, beer bottle, wine bottle, liquor bottle, vitamin or pharmaceutical bottle, can or jar, cereal box, and appliance box.

13. The system of claim 11, further comprising a server that dynamically maps said tag identifiers to, at least one of, a unique instance of a SKU, a manufacturer, and a campaign associated with said tag identifiers, wherein said tag identifiers are generated and stored on said server.

14. The system of claim 13, further comprising a reader device configured to scan contents of said tag, wherein said reader device is further configured to communicate said content of said tag to said server.

15. The system of claim 14, in which said tag content comprises an encrypted tag content that is communicated to said server, wherein said server decrypts said tag content.

16. The system of claim 14, in which said tag content comprises a hashed tag content communicated to said server, wherein said server maps a hash to said tag content.

17. The system of claim 11, wherein a tap of said anti-metal private tag layer by a first reader device is configured to convey ownership of said package to a buyer or recipient listed in said first reader device.

18. The system of claim 17, wherein said anti-metal private tag layer is further configured to allow multiple tapping from more than one reader device, in which a buyer or recipient listed in an additional reader device that taps said anti-metal private tag layer becomes a co-owner of said package for applying rebates, giving feedback, or closing referral loops.

19. The system of claim 17, wherein said anti-metal private tag layer is further configured to allow a multiple tapping from more than one reader device.

20. A system comprising:
means for hosting a product;
means for identifying, at least one of, a name of the product purchased and a user listed in a scanning device that accepted said package;
means for containing a hash or encrypted content configured to identify at least said product SKU and a unique identifier, wherein said containing means being disposed for scanning from an outside of said package; and
means for shielding, wherein shielding means being disposed between said identifying means and said determining means.

21. The system of claim 20, further comprising means for scanning or tapping said identifying means or containing means.

22. The system of claim 21, further comprising means for generating and storing identifiers for said identifying means and containing means, said generating and storing means is further configured to map said identifiers to, at least one of, a product SKU, a manufacturer, and a campaign associated with said identifiers.

23. The system of claim 22, further comprising means for communicating said identifiers between said scanning or tapping means to said generating and storing means.

24. The system of claim 21, further comprising means for communicating at least one coupon code to said scanning or tapping means for display.

25. The system of claim 24, further comprising means for a configuring a perimeter boundary within which scanned tags are considered public and outside of which are considered private.
